(19) United States
(12) Patent Application Publication
(10) Pub. No.: US 2006/0106655 A1
(43) Pub. Date: May 18, 2006

(54) System and method for coordinating travel itineraries

(76) Inventors: Ladislav Lettovsky, Avon, CO (US); Saurabh Y. Mehta, Irving, TX (US); Kyle N. Morris, Grand Prairie, TX (US); Richard M. Ratliff, Flowermound, TX (US); Rachel Abrams, New York, NY (US); Robert Albert, New York, NY (US); Sahil Gambhir, Tuckahoe, NY (US); Andy Kyle, Medford, MA (US); Richard Webby, West New York, NJ (US); Kurt Winkelman, Croton on Hudson, NY (US); David Yong, New York, NY (US); Gary J. Potter, Denton, TX (US)

Correspondence Address: ALSTON & BIRD LLP;BANK OF AMERICA PLAZA, 101 SOUTH TRYON STREET, SUITE 4000, CHARLOTTE, NC, 28280-4000, US

(21) Appl. No.: 11/236,419

(22) Filed: Sep. 27, 2005

Related U.S. Application Data
(63) Continuation-in-part of application No. 10/634,582, filed on Aug. 5, 2003.

(51) Int. Cl. G01C 21/34

(52) U.S. Cl. 705/6

(57) ABSTRACT

A method for coordinating outbound and inbound itineraries for a plurality of travelers is provided. Such a method comprises receiving a destination location, a plurality of origin locations, and travel information, wherein each origin location is associated with at least one traveler. A set of suggested outbound and inbound itineraries between each origin location and the destination location is then determined, based upon the travel information, from a travel database comprising at least outbound and inbound itineraries between the origin locations and the destination location, wherein each suggested outbound and inbound itinerary comprises an arrival time and a departure time with respect to the destination location, and the set of suggested outbound and inbound itineraries collectively provides an optimal time together of the travelers at the destination location. Associated systems and methods are also provided.

### CROSS-REFERENCE TO RELATED APPLICATIONS

This application is a continuation-in part of co-pending U.S. patent application Ser. No. 10/634,582, filed Aug. 5, 2003, which is incorporated herein in its entirety by reference.

### BACKGROUND OF THE INVENTION

1. Field of the Invention

This invention relates to techniques for the coordination of multiple travel itineraries for multiple travelers who are departing from various origin locations and traveling to the same destination location. According to one advantageous aspect, the invention provides techniques for minimizing the amount of time between the various arrival times associated with the outbound itineraries and between the various departing times associated with the inbound itineraries, such that the multiple travelers arrive at and depart from the destination at as close to the same time as possible. According to another advantageous aspect, the invention provides techniques for optimizing and/or maximizing the amount of time between the arrival times associated with the outbound itineraries and the departing times associated with the inbound itineraries, such that the multiple travelers have as much time together at the destination as possible.

2. Description of Related Art

In many types of business and personal travel, multiple travelers are expected to arrive at the same destination to participate in the same or similar activity. Frequently, the multiple travelers must originate their travel from different origin locations. For instance, a manager of a business with employees located in more than one city, state or country may call a meeting that requires all employees of the business to gather at a certain location and time. Furthermore, a family reunion may be planned, which requires the family members, many of whom do not live in the same place, to gather at a certain location and time. Thus, many of the employees and family members must travel to the certain location prior to the time of the meeting or reunion, respectively. For the travelers that do not drive themselves, such as those that arrive at the destination via a plane, train or other mode of mass transportation, it would generally be advantageous for them to arrive at the destination around the same time so that they can more easily share the other travel expenses, such as lodging arrangements, transportation to the lodging, transportation to the activity, etc. As such, two or more of the travelers may desire to coordinate their travel itineraries so that they arrive at the destination at as close to the same time as possible. In the same way, the travelers may also desire to coordinate their travel itineraries so that they depart the destination at as close to the same time as possible so that they may share transportation expenses to an airport, train station, or other departing location, or for any other reason. In some instances, such as the aforementioned family reunion or a vacation, the travelers may further desire to coordinate their travel itineraries so as to maximize their time spent together at the destination location.

Coordinating travel arrangements for two or more travelers can be a daunting task, however, and the more travelers there are, the more complicated an endeavor it is to coordinate travel arrangements. Typically, if more than one traveler from different origin locations would like to arrive at and/or leave a destination location at approximately the same time, someone must personally evaluate all of the possible travel arrangements (itineraries) for each traveler and determine which itinerary for each traveler will permit the travelers to arrive at and/or leave the destination as close as possible to the same time. Simultaneously, the person evaluating all of the possible travel itineraries for each traveler must keep in mind the date and time of any activity or activities that any or all of the travelers must attend. The scenario may be further complicated if the travelers wish to spend as much time together at the destination as possible, in addition to or in the alternative to arriving at and/or leaving the destination as close as possible to the same time

For example, a travel organizer faced with such a task, such as a travel agent or other individual, who may or may not be a traveler themselves, typically accesses a central reservation system for the desired type of transportation and performs separate searches to obtain the various travel itineraries for traveling to a certain destination from each traveler's origin location that meet the overall travel criteria, such as the date for the travel. Once the travel organizer obtains the various travel itineraries for each traveler, the travel organizer must then manually evaluate the itineraries in light of the particular desires of the travelers. For example, if the travelers and/or organizer specify that the travelers should arrive at and/or depart from the destination at as close to the same time as possible, regardless of the cost, then the travel organizer must determine which itineraries meet only the specific scheduling requirements. If, however, the travelers and/or organizer specify that the travelers should arrive at and/or depart from the destination at as close to the same time as possible without exceeding a certain price for one or more of the itineraries, or a certain overall price for all of the itineraries, then the organizer must not only evaluate the itineraries in light of the schedule requirements, but also must consider the pricing of one or more of the itineraries in making an appropriate determination. As such, as the number of travelers and/or the number of itineraries that the travel organizer must evaluate increases, the risk also increases that the organizer will become confused by the amount of information to be processed, or that the organizer will make an error or overlook a viable travel option for one or more of the travelers. Furthermore, if one or more of the travelers desires to make changes to their respective itinerary, the organizer must manually gather and identify all of the additional viable travel options to present to the respective traveler based, for example, upon the schedule and/or price requirements. Then, if a change is made to one traveler's itinerary, the organizer must further determine how that change affects the other travelers' waiting times once they arrive at the destination and/or the prices of the travel. Manually coordinating travel itineraries for multiple travelers who are traveling from different origin locations to one destination location, therefore, has the possibility of being a very time-consuming and error-prone process. Adding other parameters to the organizer's task such as, for example, the desire of the travelers to spend as much time together at the destination location as possible, further complicates the analysis.

Thus, there exists a need for a method and system for coordinate the travel itineraries of multiple travelers arriving at and leaving from a destination location, but originating travel from multiple origin locations. More particularly, there exists a need for a system and method capable of coordinating the travel itineraries of multiple travelers based upon specified requirements regarding schedule and/or pricing and/or an optimum and/or maximum time together at the destination location, as well as capable of addressing changes to individual travel itineraries as desired by the particular traveler in light of the coordinated travel plans of the other travelers, in an efficient and accurate manner.

### BRIEF SUMMARY OF THE INVENTION

According to the present invention, the methods and systems for coordinating the travel itineraries of multiple travelers, who are leaving from more than one origin location, but are arriving at the same destination location, provide automated techniques for quickly and accurately determining which travel itineraries for each traveler best meet the specified criteria for the trip and/or allow the travelers to spend an optimum and/or maximum amount of time together at the destination location. For example, methods and systems of the present invention permit a travel organizer to specify certain travel criteria for a trip, such as the date(s) of travel or the relative importance of the travelers arriving at the destination location at as close to the same time as possible (i.e. the schedule) versus the overall price of the itineraries for all of the travelers (i.e. the price). The methods and systems then provide a set of suggested travel itineraries that most closely meets the specified criteria, in addition to providing the amount of time between when any two travelers arrive at the destination location and/or the amount of time between when any two travelers leave from the destination location, the amount of time that the travelers will spend together at the destination location, and the overall price or individual prices for each traveler. Furthermore, the travel coordination techniques provide flexibility by allowing the organizer and/or the travelers to view all of the possible itineraries, replace one or more of the suggested itineraries, and then recalculate the time amounts and the price(s).

One embodiment of the methods and systems for coordinating multiple outbound and inbound itineraries includes receiving a destination location, multiple origin locations, each of which is associated with at least one traveler, and other travel information, such as, but not limited to, the dates and desired times of travel. An indication regarding the relative weight between price and schedule of at least some of the outbound and inbound itineraries is also received. For instance, one or more client elements, such as a laptop computer, a personal computer or workstation, networked personal computers or workstations, or the like, may receive the information. A travel database that includes at least outbound and inbound itineraries may then be accessed, such as by a processing element, and at least one outbound and inbound itinerary between the destination location and each origin location is identified based upon the travel information provided. From the identified itineraries, a suggested outbound and inbound itinerary between the destination location and each origin location may be determined based upon the relative weight between schedule and price; again typically by a processing element. Furthermore, one or more storage elements may store all of the identified itineraries.

Other embodiments of the methods and systems include presenting the suggested outbound and inbound itineraries for review, such as via one or more display elements. If a traveler or the travel organizer desires to review alternatives to at least one of the suggested itineraries, an indication that alternative itineraries are desired for at least one of the suggested itineraries associated with a respective traveler may be received. If an indication that alternative itineraries are desired is received, then other identified outbound and inbound itineraries between the destination location and an origin location may be presented for review. An indication of a selection of at least one of the other identified outbound and inbound itineraries may then be received. Embodiments of the present invention also may include transmitting the suggested itineraries and/or the identified itineraries associated with a traveler to the respective traveler for their review and selection. In further embodiments, information associated with the destination location may also be presented when the suggested and/or the identified itineraries are presented.

Changes to the indication regarding the relative weight between schedule and price for at least one of the travelers and/or at least one of the travel itineraries may be received in certain embodiments of the methods and systems of the present invention. The identified itineraries may then be accessed and at least one modified suggested itinerary between the destination location and at least one of the origin locations may be determined based upon the received changes, and may replace the suggested itinerary.

The total price for all of the suggested itineraries and/or the price for each suggested itinerary for each traveler may be determined. In addition, if one or more of the suggested itineraries are replaced with other identified itineraries, then the total price and individual prices for the resulting selected itineraries may be determined. Embodiments of the methods and systems of the present invention also include a determination of the amount of time between when any two travelers arrive at or depart from the destination location. For example, a determination of the amount of time between when each traveler arrives at the destination location and when the last traveler arrives at the destination for each suggested outbound itinerary may be made. Similarly, a determination of the amount of time between when each traveler departs the destination location and when the first traveler departs the destination location for each suggested inbound itinerary may be made. In one embodiment, the suggested outbound and inbound itineraries are the itineraries in which the amount of time between the arrival times of a respective traveler, and/or the amount of time between the departure times of a respective traveler, and at least one other traveler are minimized. Again, if one or more of the suggested itineraries are replaced with other identified itineraries, then the time amounts for the resulting selected itineraries may be determined.

Further embodiments of the methods and systems for coordinating travel itineraries may include receiving hotel and/or car rental information associated with at least one of the travelers. A travel database that includes respective hotel and/or car rental information may be accessed and at least one hotel and/or car rental itinerary, respectively, may be identified based upon the received information. The identified hotel and/or car rental itineraries, respectively, may be presented for review, and an indication of a selected hotel and/or car rental itinerary, respectively, may then be received.

The methods and systems of the present invention may also receive payment information regarding how the travel costs for each traveler are to be paid in some embodiments. Billing information may then be transmitted to the appropriate travelers or other entity or individual based upon the contents of the payment information.

In an alternate embodiment, methods and systems are provided for coordinating outbound and inbound itineraries for a plurality of travelers after receiving, by at least one client element, a destination location, a plurality of origin locations, and travel information, wherein each origin location is associated with at least one traveler. Upon receiving these parameters, such methods and systems determine a set of suggested outbound and inbound itineraries between each origin location and the destination location, based upon the travel information, from a travel database comprising at least outbound and inbound itineraries between the origin locations and the destination location, using at least one processing element. Each suggested outbound and inbound itinerary comprises an arrival time and a departure time with respect to the destination location, and the set of suggested outbound and inbound itineraries are determined so as to collectively providing an optimal time together of the travelers at the destination location.

In yet another alternate embodiment, methods and systems are provided for coordinating outbound and inbound itineraries for a plurality of travelers. First, a destination location, a plurality of origin locations, and travel information, is received, for example, by at least one client element, wherein each origin location is associated with at least one traveler. At least one processing element then determines at least one suggested outbound and inbound itinerary between each origin location and the destination location, based upon the travel information, from a travel database comprising at least outbound and inbound itineraries between the origin locations and the destination location. The at least one processing element is further capable of concurrently presenting one of an outbound portion and an inbound portion of the suggested outbound and inbound itineraries, arranged according to the corresponding origin location on at least one client element, wherein the one of the outbound portion and the inbound portion of the at least one suggested outbound and inbound itinerary for one of the plurality of origin locations is sortable according to an attribute of the suggested outbound and inbound itineraries, discretely of the corresponding one of the outbound portion and the inbound portion of the at least one suggested outbound and inbound itinerary for each of the others of the plurality of origin locations. The attribute may comprise, for example, a selected airline, an arrival time with respect to the destination location, a departure time with respect to the destination location, a total travel time, an amount of stops between the origin location and the destination location, and a cost.

Thus, the methods and systems for coordinating outbound and inbound itineraries for multiple travelers according to the various embodiments of the present invention provide automated techniques for providing a travel organizer and/or individual travelers with accurate and timely travel itinerary suggestions and options that best meet their travel criteria, such that the coordination of outbound and inbound travel itineraries for travelers from different origin locations traveling to the same destination location can more easily obtain the travel itineraries that will permit them to arrive at the destination location at similar times and/or depart from the destination location at similar times and/or identify travel itineraries that will permit them to identify the time spent together for each travel itinerary suggestion and to thereby spend an optimal or maximum amount of time together at the destination location. Additionally, the embodiments of the methods and systems of the present invention provide travel organizers and/or travelers with the ability to review the various travel options and easily change their travel itineraries. As such the methods and systems of the present invention are much less time-consuming and less error-prone than manual searching, identification and coordination of such travel itineraries.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a diagram of one example of the network elements that may be utilized to implement the methods and systems of embodiments of the present invention;

FIG. 2 is a representative display, according to one embodiment of the present invention, in which a travel organizer may enter a destination location, multiple origin locations and other travel information associated with two or more travelers for coordinating travel itineraries;

FIG. 3 is a representative display, according to one embodiment of the present invention, presenting suggested itineraries that most closely meet the criteria entered by the travel organizer in FIG. 2 and presenting further options regarding the selection of specific itineraries and payment options;

FIG. 4 is a representative display, according to one embodiment of the present invention, presenting all of the identified coordinated travel itineraries between an origin and a destination location;

FIG. 5 is a representative display, according to one embodiment of the present invention, transmitting and presenting the details of the travel information of selected itineraries associated with a traveler along with billing information;

FIG. 6 is a representative display, according to an alternate embodiment of the present invention, in which a travel organizer may enter a destination location, multiple origin locations and other travel information associated with two or more travelers for optimizing time spent together at a destination location;

FIG. 7 is a representative display, according to the embodiment of the present invention shown in FIG. 6, presenting groups of flight plus lodging results in response to the criteria entered by the travel organizer in FIG. 6 and presenting further options regarding the selection of particular sets of itineraries in each group;

FIG. 8 is a representative display, according to the embodiment of the present invention shown in FIG. 7, presenting lodging selections in response to the group selected by the travel organizer in FIG. 7;

FIG. 9 is a representative display, according to the embodiment of the present invention shown in FIG. 8, presenting sets of suggested airfare itineraries for selection by the user, with each set of itineraries providing an indication of the time spent together by the travelers at the destination location;

FIG. 10 is a representative display, according to the embodiment of the present invention shown in FIG. 6, presenting groups of flight plus car results in response to the criteria entered by the travel organizer in FIG. 6 and presenting further options regarding the selection of particular sets of itineraries in each group;

FIG. 11 is a representative display, according to the embodiment of the present invention shown in FIG. 10, presenting sets of suggested airfare itineraries for selection by the user, with each set of itineraries providing an indication of the time spent together by the travelers at the destination location;

FIG. 12 is a representative display, according to the embodiment of the present invention shown in FIG. 11, presenting car rental selections in response to the group selected by the travel organizer in FIG. 11; and

FIG. 13 is a representative display, according to one embodiment of the present invention involving an airfare plus hotel package scenario, concurrently presenting suggested outbound airfare itineraries arranged according to origin location, in this instance, in a side-by-side arrangement, whereby the suggested airfare itineraries under one origin location are sortable according to an attribute, discretely with respect to sorting of the suggested airfare itineraries under the other origin locations.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

According to the present invention, the methods and systems for coordinating the travel itineraries of multiple travelers, who are leaving from one or more origin locations, but are arriving at the same destination location, provide automated techniques for quickly and accurately determining which travel itineraries for each traveler best meet the specified criteria for the trip while providing the travelers with the optimum or maximum time spent together at the destination location. For example, the methods and systems of the present invention permit a travel organizer to specify certain travel criteria for a trip, such as, for example, the date(s) of travel and preferred times of departure and/or arrival. In some instances, the travel organizer may also include other criteria or preferences such as, for instance, the relative importance between the travelers arriving at the destination location at as close to the same time as possible (i.e. the schedule) and the overall price of the itineraries for all of the travelers (i.e. the price). Such methods and systems then provide a set of suggested travel itineraries that most closely meets the specified criteria, and also provides an indication of the amount of time together for the travelers corresponding to each of the suggested travel itineraries. In addition, the amount of time between when any two travelers arrive at the destination location and/or leave from the destination location, and the overall price or individual prices for each traveler traveling to and from the destination location may also be provided. Furthermore, the travel coordination techniques provide flexibility by allowing the organizer and/or the travelers to view all of the possible itineraries and select one or more of the alternate suggested itineraries, wherein each of the suggested itineraries is associated with an amount of time together for the travelers. In some cases, selection of an alternate itinerary also causes the arrival/departure time difference amounts and the price(s) associated with each suggested itinerary to be recalculated.

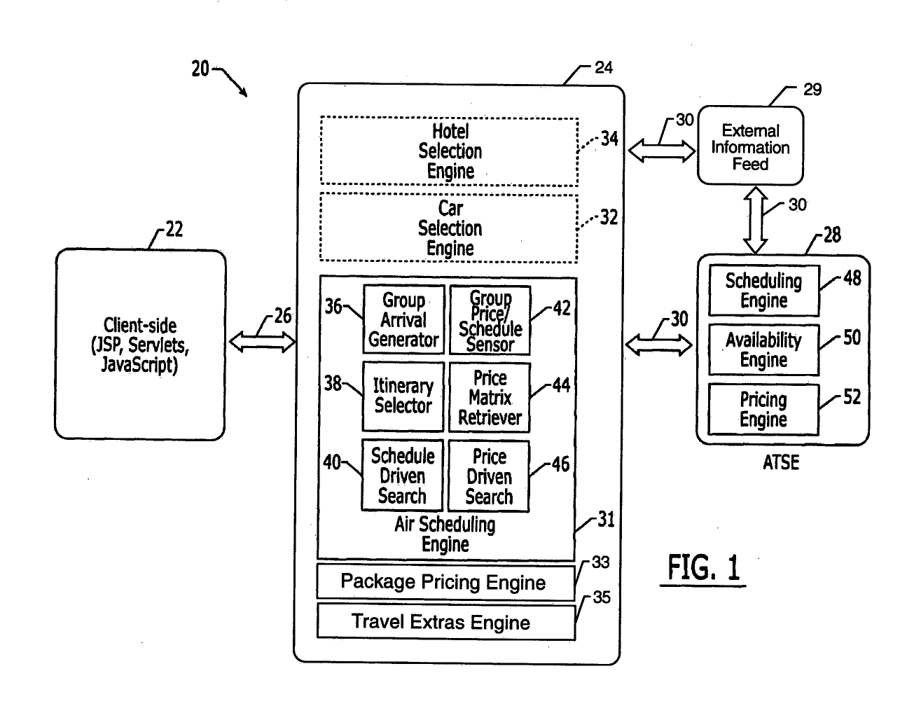

FIG. 1 is a network diagram of a system 20 for coordinating outbound and inbound travel itineraries to determine time together, according to one embodiment of the present invention. The system 20 typically includes at least one client element 22 and at least one server connected via at least one computer network 26. For example, the server may be a web server and an application server that may be located on the same physical device or the web server may be separate from and in communication with the application server via the Internet, intranet or any other computer network. The system also generally includes at least one processing element 24. As shown in FIG. 1, the processing element(s) 24 of one embodiment may be embodied by the server, such as the web server and/or the application server. The client element(s) 22 and the processing element(s) 24 and, in one embodiment, the web and application server(s) may be distributed as parts of different workstations, computers, servers or computing devices that may be in different physical locations and in communication with each other via the Internet, intranet or other computer network(s) 26. To be consistent, the discussion hereinafter refers to the different elements of the system 20 as being distributed, unless otherwise stated. In an alternative embodiment, however, the client element(s) 22 and the processing element(s) 24 may be part of a single workstation, computer, server or other computing device and, as such, may communicate with each other via internal transmissions.

The database 28 of the travel itinerary coordination system 20 may be part of one or more of the client element(s) 22, the server, and/or one or more of the processing element(s) 24, or most likely, may be separate from the client element(s) 22, the server, and the processing element(s) 24 and in communication with one or all of the elements via the Internet, intranet or other computer network(s) 30. Regardless of the configuration, the database 28 is accessed by other elements of the travel itinerary coordination system 20 via an interface, such as, but not limited to, a Common Object Request Broker Architecture (CORBA), active data object (ADO) interface, open database connectivity (ODBC) interface, or web services.

The client element(s) 22 represent the device or devices that users of the travel itinerary coordination system 20 may utilize to perform their duties regarding the travel data, such as to request inbound and/or outbound itineraries for travelers arriving in one destination location from more than one origin location, and/or to select particular inbound and/or outbound itineraries. The client element(s) 22 may be a laptop computer, a personal computer or workstation, networked personal computers or workstations, or any other type of computing device or configuration operating on any type of computer platform and capable of communications with the server(s). For example, the client element(s) 22 may support a browser interface to permit communications with the server(s). The browser interface is generally an Internet browser, but other browser interfaces capable of appropriately displaying the travel data, soliciting user input, and communicating with the computer network 26 may be utilized if desired. The system 20 may include many client elements 22 such that many users may utilize the travel itinerary coordination system 20. The client element(s) 22 may physically be located anywhere as long as the client element(s) 22 are in communication with the processing element(s) 24 via the Internet, intranet or other computer network 26.

As described above, the processing element(s) 24 of one advantageous embodiment include a web and application server, which may utilize any modem operating system, such as, but not limited to, Microsoft Windows, UNIX, or Linux, and any modem web development platform, such as, but not limited to, JAVA, commercially available from Sun Microsystems, Inc. One or more application program(s) may reside on the web and application server(s). For example, in the embodiment of the network architecture diagram of FIG. 1, the processing element(s) 24 include an Air Scheduling Engine 31, a Car Selection Engine 32, a Package Pricing Engine 33, a Hotel Selection Engine 34, and a Travel Extras Engine 35. Furthermore, the Air Scheduling Engine 31 application program shown in FIG. 1 may include various modules, such as, but not limited to a Group Arrival Generator 36, an Itinerary Selector 38, a Schedule Driven Search 40, a Group Price/Schedule Sensor 42, a Price Matrix Retriever 44, and a Price Driven Search 46. These modules and engines are generally embodied by software, but may be a combination of hardware and software, if desired. Although the specific embodiment described with respect to FIGS. 1-5 involves air travel, the systems and methods of the present invention also encompass the coordination of any other type of travel or combination of types of travel.

Among other functions, the application program(s) provide the information/instructions required to perform a task and/or provide the requested information regarding particular travel itineraries to the client element(s) 22 in any appropriate form, such as, but not limited to, a web page form having predefined fields. The form may be viewed by the user as “screens” via client element(s) 22 and the browser interface including, for example, a display. As known to those skilled in the art, the screens may be interactive and prompt the user for the action or information necessary for the travel itinerary coordination system 20 to request, provide and allow selection of certain travel itineraries. After the user submits responses to the prompts provided by a screen and/or selects certain options presented on the screen, the application program(s) can determine the content and prompts to be provided by successive screens. The application program(s) may access/query the database 28 and/or the external information feed 29 to provide the content for any of the screens, based upon the actions taken by the user and/or the request of the user. For example, if a user, such as a travel organizer, who may or may not be a traveler themselves, requests certain travel itineraries based upon certain travel criteria for multiple travelers, the application program(s) receives the request from the user via a screen, queries the database 28 and/or the external information feed 29 for the requested information, populates and formats another screen containing the requested information, and submits the screen to the client element(s) 22 for viewing by the user, such as the travel organizer, and, optionally, one or more of the travelers, via the browser interface. Furthermore, if the particular user is to perform a task regarding the presented travel itineraries, such as selecting certain travel itineraries or providing payment information for the travel costs for one or more of the travelers, the application program(s) provides a screen to the user containing the information from the database associated with the task and prompts the user to perform the task. The information requested and received from the database 28 and/or the external information feed 29 may then be stored in the processing element(s) 24 or in a separate storage element, such that future requests for the same information may be obtained quickly from the processing element(s) 24 and/or the storage element, instead of having to query the database 28 and/or the external information feed 29 again.

The database 28 may contain a variety of stored information, including the travel data, such as, but not limited to, schedules for one or more types of travel over a period of time, availability of the travel for each schedule, and pricing of the travel for each schedule. For example, in FIG. 1, database 28 may be a global database system (GDS) or a computerized reservation system (CRS) as are known to those skilled in the art. Alternatively, the database may be an air travel database, such as an Air Travel Shopping Engine (ATSE), which contains a Scheduling Engine 48, an Availability Engine 50, and Pricing Engine 52. As used herein, the term itinerary is information that is returned from database 28, which includes schedule, availability and pricing information for a particular type of travel. The database may be any type of modern database, such as Sequel or Oracle. The data may be stored in tables in the database or in any other format known to those skilled in the art.

The external information feed 29 may be in communication with the system 20 independently of the database 28, or may form an element of the database 28, and may comprise, for example, syndicated information obtained through an RSS feed, as will be appreciated by one skilled in the art. Such syndicated information may include, for instance, calendar information of one or more of the travelers posted to a collaborative event calendar site, wherein the traveler's calendar information is then made available from that site to the system 20 through the RSS feed. In this manner, the user entering a travel query into the system 20 for a group of travelers via a client element 22 does not necessarily need to contact each traveler to determine each traveler's schedule prior to planning a trip. For example, should the user wish to propose a group trip with travelers at different origin locations over certain dates, the user would specify the particular travelers to the system 20, which would then retrieve the corresponding syndicated calendars via the external information feed 29 to determine the travelers' availability on the selected dates. If one or more travelers has a conflict with the chosen date(s), then the system 20 can, for instance, notify the user of such a conflict and permit the user to specify alternate dates.

In other instances, the system 20 may be configured to examine the calendars of the particular travelers and then present to the user an indication of particular dates where the selected travelers do not show a conflict on their corresponding calendars (particularly, for example, when the user or a traveler indicates that their travel plans are flexible). In this manner, the user is then able to prepare a proposed trip for presentation to the selected travelers (i.e., “I see from your iCalendar that you are free from January 15-20. I propose that we all meet in Cancun to escape the winter for a while. Here are the available schedules that I have found that will allow us to spend the most time together over these few days . . . ”). In some instances where the system 20 is configured to examine the calendars of the travelers, the system 20 may also be configured to determine whether alternate dates that are open on the travelers' calendars may be associated with less expensive prices with respect to airfare, hotel, and/or car, and/or provide the travelers more time together, as compared to the original dates selected by the user, and automatically present those alternate dates and the corresponding suggested itineraries to the user for consideration (i.e., “The system has determined that the travelers in your group are available to meet at the selected destination from June 12-15, instead of May 27-30 as you selected. Scheduling your trip for these alternate dates will result in a total saving of $1500.00 and allow you to spend 6.5 more hours together with the selected travelers in your group.”).

One skilled in the art will further appreciate, however, that the calendar syndication example presented above may also provide opportunities for socialization that may extend beyond the coordinated travel context as disclosed herein. For example, anyone publishing an online calendar may be allowed to choose between scheduled events entered on the calendar being made public (i.e., accessible via an RSS feed) or being private (not available via the RSS feed) or selectively available to selected individuals based on, for example, a permission-based or encryption key schema. Further, such a system implementing a syndicated calendar may also be configured to moderate the various hosted calendars by, for instance, maintaining the scheduled events on the hosted calendars in synchronization with data regarding the particular events. That is, for a scheduled event, should the dates of the event change, for example, the system may notify the user of the changed dates so as to allow the user to revisit and update their plans. Also, should the user schedule an event on or over certain dates, the system may monitor and/or verify the accuracy of the scheduled event. For example, should the user schedule an event that is determined by the system to actually being scheduled for different dates or a different location, the system may also notify the user of such discrepancies so as to allow the user to maintain an accurate calendar. With such available functionality, the syndicated calendar may allow someone to examine various online calendars, for example, and arrange travel to and/or attendance at a certain event at which persons of interest have indicated, via the syndicated calendars, that they will be attending. Accordingly, socialization opportunities may be enhanced outside a coordinated travel context. One skilled in the art will appreciate, however, that such examples presented herein regarding possible applications and functionality of an information feed aspect, particularly with respect to a syndicated calendar, are not intended to be limiting in any manner.

In addition to, or in the alternative, the syndicated information provided by the external information feed 29 may comprise travel information that is distributed based on occurring events, wherein such occurring events may include, for example, changes in fares and availability. The appropriate travel information may be provided by various systems and methods detailed, for example, in U.S. patent application Ser. No. 09/276,825, filed Mar. 26, 1999, and entitled “EVENT BASED SYSTEM FOR DISTRIBUTING TRAVEL INFORMATION,” which is incorporated herein in its entirety by reference. U.S. patent application Ser. No. 09/276,825 represents “push-type” systems and methods for providing travel information, wherein occurring events are distributed via an information channel or data channel to a subscriber or user thereof (i.e., source-distributed syndicated information). One skilled in the art will appreciate, however, that the travel information may be retrieved via the external information feed 29 using a “pull-type” system (i.e., a “fare watcher” type system where syndicated information can be distributed upon in response to an inquiry), wherein, for example, appropriate systems and methods may be implemented to selectively or periodically query a travel information database or data channel in order to determine whether there have been any changes in, for example, fares and availability (i.e., a feed reader or aggregator). Accordingly, monitoring such events or changes in the travel information queried by the system 20 allows the time together method to provide optimum representations of the time together for the travelers corresponding to each of the suggested itineraries returned to the user in response to a particular query.

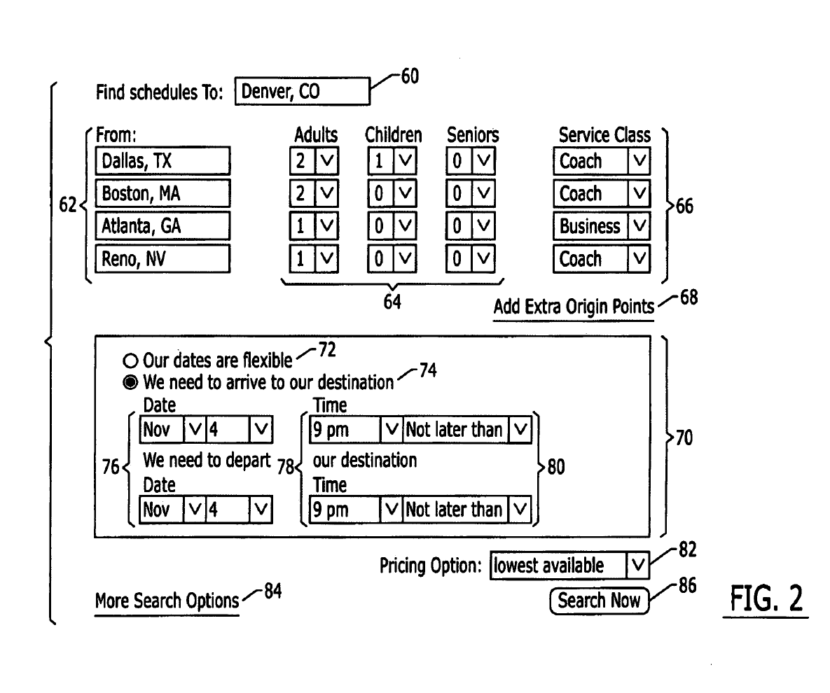

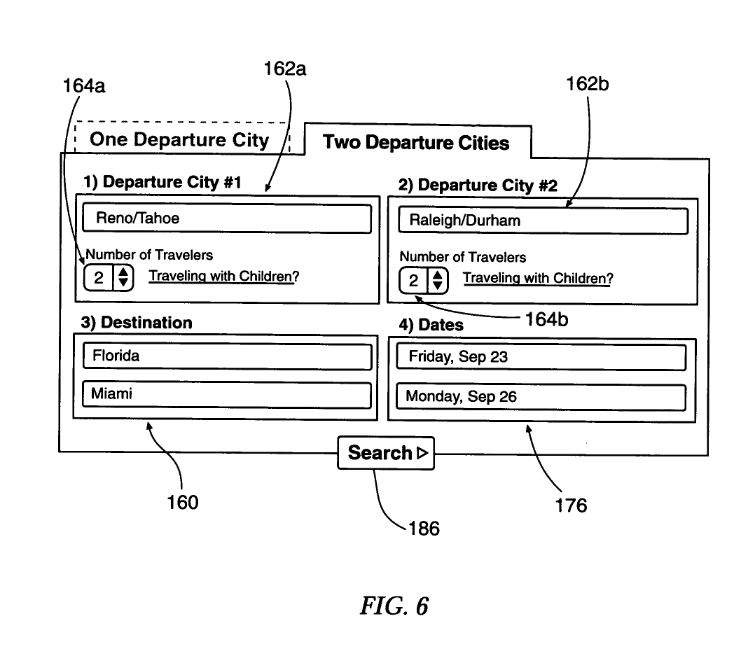

As discussed, embodiments of the present invention generally include two concepts that may be implemented simultaneously or independently, as will be appreciated by one skilled in the art. The first concept is directed to minimizing the amount of time between the various arrival times associated with the outbound itineraries and between the various departing times associated with the inbound itineraries, such that the multiple travelers arrive at and depart from the destination at as close to the same times as possible. The second concept is directed to optimizing or maximizing the amount of time between the arrival times associated with the outbound itineraries and the departing times associated with the inbound itineraries, such that the multiple travelers have as much time together at the destination as possible. Optimizing the amount of time together may indicate, for example, balancing the maximum amount of time together with other travel parameters such as cost, wait times, layover time, travel times, and/or hotel and/or rental car availability. As such, an optimized time together may or may not be the maximum amount of time together for the travelers, since the optimized time together may represent other factors playing a role in the itineraries presented to the user (i.e., a suggested itinerary with less than a maximum time together, such as 2 days and 3 hours for $1000.00, may be presented to the user where an itinerary with the maximum time together, such as 2 days and 5 hours for $2000.00, may be significantly more expensive). These concepts may both be implemented using a system 20 disclosed herein, though the methodology therebetween may vary as appropriate. Accordingly, for clarity, the methodology of the first concept (“the travel itinerary coordination method” as illustrated in FIGS. 2-5) is first discussed, followed by a discussion of the methodology of the second concept (“the time together method” as illustrated in FIGS. 6-13)

FIG. 2 illustrates a set of general options and prompts that may be presented to a user of the method and system 20 of the present invention. For example, in FIG. 2, a user, such as a travel organizer, is prompted to enter a destination location in the box 60 that follows the words “Find Schedules To:”, which is Denver, Colo. in this example. A user is further prompted to enter the origin locations for the travelers in the boxes 62, which are Dallas, Tex., Boston, Mass., Atlanta, Ga., and Reno, Nev. in this example. The user is also prompted to select the number and type, i.e., adults, children or seniors, of people that are traveling from each origin location in the boxes 64. For instance, in the example of FIG. 2, the user has indicated that 2 adults and 1 child will be traveling from Dallas, 2 adults will be traveling from Boston, 1 adult will be traveling from Atlanta, and 1 adult will be traveling from Reno. To enter the numbers in the boxes 64, a user may select the box and utilize a keyboard associated with a client element 22 to enter the desired number in the box or select the arrow to the right of the box, such as with a mouse or other selection device associated with a client element 22, which may provide a list of all of the options for the numbers that may be entered into the box, then select the desired number from the list.

The user, such as a travel organizer, may also be prompted to enter the class of travel for all or each of the travelers from each origin location. The example of FIG. 2 illustrates options in which the user is prompted to enter a class of travel for all of the travelers from each origin location in boxes 66. For instance, in the example of FIG. 2, the class of travel entered for all of the travelers from Dallas, Boston and Reno is coach class, while the class of travel entered for the traveler from Atlanta is business class. Again, to enter the class in the boxes 66, a user may select the box and utilize a keyboard associated with a client element 22 to enter the desired class in the box or select the arrow to the right of the box, such as with a mouse or other selection device associated with the client element 22, which may provide a list of all of the options for the service class that may be entered into the box, then select the desired class from the list. An option to add additional origin points may also be presented to the user, such as the option 68 shown in the FIG. 2 example. If a user selects this option, such as with a mouse or other selection device associated with a client element 22, more boxes 62, 64, and 66 may be presented to the user. For instance, additional boxes may appear below the existing boxes 62, 64, and 66 shown in FIG. 2.

Furthermore, the user may be prompted to enter the desired dates and times for travel. As shown in segment 70 of the example of FIG. 2, the user may select an option 72 indicating that the travelers are flexible concerning their travel dates or the user may select option 74 and indicate the exact date and/or time that the travelers wish to arrive at and depart from their destination. Specifically, the user may enter the exact arrival and departure dates in the boxes 76, as shown in FIG. 2, in the same way as explained above with respect to boxes 62, 64, and 66. The user may also enter arrival and departure times in the boxes 78. In some embodiments, the user may enter an exact time in the boxes 78, or, as shown in the embodiment of FIG. 2, the user may select the arrow to the right of the box, such as with a mouse or other selection device associated with the client element 22, which may provide a list of all of the times that may be entered into the box, and then select the desired time from the list. In addition, in the embodiment shown in FIG. 2, the user may select certain phrases or words from boxes 80 that further define the desired arrival and departure times. For example, in the embodiment of FIG. 2, the user may select among “Not later than,” or “Approximately” to further define the desired arrival time, and “Not earlier than,” or “Approximately” to further define the desired departure time. If “Not later than” or “Not earlier than” is selected, then itineraries that provide arrival or departure times, respectively, as close as possible to the selected time without any arrival times that are earlier than or later than the selected time, respectively, are desired. If “Approximately” is selected, then itineraries that provide arrival or departure times as close as possible to the selected time, whether before or after the selected time are desired. Thus, in the embodiment of FIG. 2, the user has indicated that the travelers should arrive at their destination not later than 9 pm on November 4 and should depart from their destination not earlier than 2 pm on November 10.

The pricing option box 82 also permits the user, such as the travel organizer, to indicate the relative importance of the travel price to the travel schedule. Thus, the user may select certain phrases from box 82, which may be listed when the user selects the arrow to the right of the box, as described hereinabove. For example, in the embodiment of FIG. 2, the user may select among the phrases “lowest available” or “unrestricted” to indicate how important the price of travel is compared with the schedule of travel. A selection of the “lowest available” pricing option indicates that the lowest price itineraries that also meet the date and time requirements are desired, but that the desired itineraries do not have to be the closest to the date and time requirements. A selection of the “unrestricted” pricing option indicates that the itineraries that meet the date and time requirements as closely as possible, regardless of the price, are desired. As such, the amounts of time between when the travelers arrive at or depart from the destination may be larger when the “lowest available” pricing option is selected than the amounts of time between when the travelers arrive at or depart from the destination when the “unrestricted” pricing option is selected. In the embodiment of FIG. 2, the user has indicated that the lowest available pricing is desirable, such that the travel itinerary coordination system 20 will find the lowest cost travel itineraries that will still arrive at and depart from the destination location within the desired timeframes, but may not be the itineraries that most closely meet the timeframes.

The “more search options” selection 84 expands the search options that the user may enter to further define the user's and/or the traveler's desires regarding the travel itineraries of one or all of the travelers. For example, by selecting the “more search options” selection 84, the user may be presented with the ability to select the service class for each traveler, not just for all of the travelers from one origin, as shown in FIG. 2. The user may also be presented with options to further define the desired length of travel for one or more of the travelers. For example, the user may be permitted to indicate the maximum number of connections, if any, each traveler should have in the respective traveler's itinerary. These options also may include options for entering ground transportation, such as car rental, requirements for one or more of the travelers and lodging, such as hotel rental, requirements for one or more of the travelers. Further options may include, but are not limited to, options to indicate the desired carrier for each traveler, each traveler's email address, and/or pricing options for each traveler. The options described above are examples of general options that may be available to users of the system 20. Other options may be added or the options described above may be combined in other embodiments of the system 20 of the present invention. Once the user has entered all of the information regarding the travel and the travelers, the user may select the “search now” box 86 to initiate a search by the travel itinerary coordination system 20 for travel itineraries that best match the information.

The travel itinerary coordination method and system 20 initiate the search by requesting, from the travel database 28, all of the travel itineraries that most closely meet the requirements entered by the user, such as the travel organizer, as described above. In transmitting any of the requests discussed herein, one request containing all of the desired information may be transmitted to the database 28, or separate requests for each origin location or each traveler may be transmitted to the database.

The information entered by the user, such as the travel organizer, in FIG. 2 is therefore transmitted to the processing element 24 that then transmits the information to the travel database 28. In the discussion that follows, a specific embodiment of the travel itinerary coordination method and system 20 is described, in which air travel itineraries are coordinated utilizing specific modules of the processing element 24, and in particular, the air scheduling engine 31, and the database 28. The present invention, however, is not limited to this embodiment and may utilize other types of travel itineraries and other hardware and software known to those skilled in the art to accomplish the same results without departing from the spirit and scope of the present invention. For example, car rental and/or hotel rental may also be coordinated by the travel itinerary coordination method and system 20 of the present invention by utilizing one or more application program in the car selection engine and/or the hotel selection engine 34, respectively.

In the example of the embodiment of the system 20 illustrated by FIG. 1, the travel database 28 utilizes the scheduling engine 48 to identify all of the outbound and inbound itineraries between each origin and the destination that meet the date and time requirements and any other requirements as closely as possible. If more specific requirements were also entered by the travel organizer for one or more travelers, such as a specific airline or maximum number of connections, then the scheduling engine 48 also considers those requirements when identifying the itineraries. If, however, fewer than a minimum number of itineraries are identified that meet the requirements, the scheduling engine 48 will identify other itineraries that meet all but one or more of the requirements. For example, if a particular traveler requires or prefers a specific airline and direct flights, but the scheduling engine 48 identifies no itineraries or less than a minimum number of itineraries meeting those requirements on the dates and at the times requested, then the scheduling engine 48 will look to itineraries of other airlines and/or connecting flights that still meet the requested dates and times.

Once all of the outbound and inbound itineraries between each origin and the destination that meet the date and time requirements and any other requirements as closely as possible are identified, then the travel database 28 also obtains the availability of those itineraries from the availability engine 50. For example, the availability engine 50 checks to determine whether each of the flights has one or more available seats for the traveler(s). In addition, the availability engine 50 may check to determine whether each of the flights has seats available in the class of service specified for each traveler that may potentially book the flight. If one or more of the flights do not have any seats available, do not have enough seats available for all of the travelers that may potentially book the flight, or do not have the desired class of service seats available, then the respective itineraries may be flagged to indicate the lack of availability or the respective itineraries may be deleted from the list of itineraries that the scheduling engine 48 obtained.

The prices of the identified itineraries may then be obtained. The price may be obtained in any conventional manner. For instance, in the embodiment of FIG. 1, the pricing engine 52 of the database 28 provides one or more price matrix that includes the prices for each inbound itinerary with any outbound itinerary and each outbound itinerary with any inbound itinerary. The price matrix or matrices are then transmitted to the Price Matrix Retriever 44 of the processing element 24.

The itineraries between each origin location and the destination location then may be transmitted to the processing element 24, in particular, the air scheduling engine 31. In the embodiment of the system 20 of FIG. 1, the Group Arrival Generator 36 receives the itineraries and creates an n×n matrix of the itineraries, where n=the number of travelers. The matrix contains each of the itineraries, and for each itinerary associated with an origin, the elapsed time (et), which, for outbound itineraries, is the amount of time between when the traveler arrives at the destination and when the traveler departed from the origin, and, for inbound itineraries, is the amount of time between when the traveler arrives at the origin and when the traveler departed from the destination. The outbound and inbound itineraries having the minimum et are determined, then the Δet=et−minimum et for each itinerary is calculated and associated with the respective itinerary. With respect to the embodiment of the system 20 illustrated in FIG. 2, all of the et determinations and computations are performed by the Itinerary Selector 38. The price for each outbound and inbound itinerary is then obtained from the Price Matrix Retriever 44 and associated with each itinerary. Thus, all of the identified itineraries and their prices are stored in the processing element 24 and/or in a storage element in communication with the processing element 24, such that the system 20 does not have to access the travel database 28 if the travel organizer and/or any of the travelers desire to modify the relative weight assignment between schedule and price or to view all of the identified itineraries.

Groups of outbound itineraries and groups of inbound itineraries in which each group has one itinerary associated with each traveler are then created by the Group Price/Schedule Sensor 42. To create the groups, first an empty list of labels is created for each arrival time slot, where there is one arrival time slot for each arrival time of each of the itineraries associated with the same origin location. Thus, a label is created for each itinerary that arrives at or before the arrival time slot. For example, if there are three itineraries from an origin to a destination and itinerary 1 arrives at the destination at 8 am, itinerary 2 arrives at the destination at 9 am, and itinerary 3 arrives at the destination at 10 am, then only itinerary 1 will have a label for the 8 am time slot, itineraries 1 and 2 will have labels for the 9 am time slot, and itineraries 1, 2 and 3 will have labels for the 10 am time slot. Each label contains at least (1) the Δet+the amount of time between the arrival time slot and the arrival time for the itinerary (i.e., the waiting time); (2) price and (3) itinerary identifier.

For instance, assume that itineraries 1, 2 and 3 departing from origin 1 have the following details:

| | | Departing | Arrival | | et | |
|---|---|---|---|---|---|---|
| Itinerary | Identifier | Time | Time | Stops | (minutes) | Price |
| 1 | AA1 | 5:30 am | 8:00 am | 1 | 150 | $150 |
| 2 | AA2 | 5:30 am | 9:00 am | 1 | 210 | $130 |
| 3 | AA3 | 8:00 am | 10:00 am | 0 | 120 | $200 |

Thus, itinerary 3 has the minimum et at 120 minutes. Itinerary 1 has a Δet=30, and itinerary 2 has a Δet=90.

For the 8:00 am time slot, the label for itinerary 1 is:

| | |
|---|---|
| (1) | 30 |
| (2) | 150 |
| (3) | AA1 |

For the 9:00 am time slot, the labels for itinerary 1 and itinerary 2, respectively are:

| | |
|---|---|
| (1) | 90 |
| (2) | 150 |
| (3) | AA1 |
| (1) | 90 |
| (2) | 130 |
| (3) | AA2 |

Because more than one label exists for this time slot, the Group Price/Schedule Sensor 42 determines whether to eliminate any of the itineraries. Thus, an itinerary and the associated label may be eliminated if the time amount in (1) for a respective itinerary is greater than or equal to the time amount in (1) for the other itineraries and the price in (2) for the respective itinerary is greater than the price in (2) for the other itineraries. Likewise, an itinerary and the associated label may be eliminated if the price in (2) for the respective itinerary is greater than or equal to the price in (2) for the other itineraries and the time amount in (1) for a respective itinerary is greater than the time amount in (1) for the other itineraries. For example, regarding the labels in the 9:00 am time slot, the AA1 itinerary may be eliminated because the time amount in (1) for the AA1 itinerary is the same as the time amount in (1) for the AA2 itinerary and the price in (2) for the AA1 itinerary is greater than the price in (2) for the AA2 itinerary. Once an itinerary has been eliminated for one time slot, it is also eliminated in any subsequent time slots. Thus, a label for itinerary 1 (i.e. AA1) will not be created for any subsequent time slots.

For the 10:00 am time slot, the labels for itinerary 2 and itinerary 3, respectively are:

| | |
|---|---|
| (1) | 150 |
| (2) | 130 |
| (3) | AA2 |
| (1) | 0 |
| (2) | 200 |
| (3) | AA3 |

Following the rules set forth above, neither of these labels and associated itineraries may be eliminated because while the time amount in (1) for the AA2 itinerary is greater than the time amount in (1) for the AA3 itinerary, the price in (2) for the AA2 itinerary is less than the price in (2) for the AA3 itinerary. Likewise, while the price in (2) for the AA3 itinerary is greater than the price in (2) for the AA2 itinerary, the time amount in (1) for the AA3 itinerary is less than the time amount in (1) for the AA2 itinerary. Thus, a matrix for origin 1 is created in which the 8:00 am time-slot has one label (i.e., the AA1 itinerary), the 9:00 am time slot has one label (i.e., the AA2 itinerary), and the 10:00 am time slot has two labels (i.e., the AA2 and AA3 itineraries). Such a matrix is created for each origin location.

Once the matrices for each origin location are created as described above, a matrix is created for the various groups of itineraries in which each group contains an itinerary for each traveler associated with an origin location. For example, assume that itineraries 1, 2 and 3 departing from origin 2 have the following details:

| | | Departing | Arrival | | Et | |
|---|---|---|---|---|---|---|
| Itinerary | Identifier | Time | Time | Stops | (minutes) | Price |
| 1 | DL1 | 7:40 am | 8:50 am | 1 | 70 | $120 |
| 2 | DL2 | 7:20 am | 9:30 am | 1 | 130 | $100 |
| 3 | DL3 | 10:10 am | 11:00 am | 0 | 50 | $20 |

Thus, itinerary 3 has the minimum et at 50 minutes. Itinerary 1 has a Δet=20, and itinerary 2 has a Δet=80.

Thus, for the 10:00 am time slot, the labels for itinerary 1 and itinerary 2 from origin 2 are:

| | |
|---|---|
| (1) | 90 |
| (2) | 120 |
| (3) | DL1 |
| (1) | 110 |
| (2) | 100 |
| (3) | DL2 |

For an 11:00 am time slot, the labels for itinerary 1, itinerary 2 and itinerary 3 from origin 2 are:

| | |
|---|---|
| (1) | 90 + 60 = 150 |
| (2) | 120 |
| (3) | DL1 |
| (1) | 110 + 60 = 170 |
| (2) | 100 |
| (3) | DL2 |
| (1) | 0 |
| (2) | 20 |
| (3) | DL3 |

Following the rules set forth above, neither of the labels and associated itineraries may be eliminated for the 10:00 am time slot because while the time amount in (1) for the DL2 itinerary is greater than the time amount in (1) for the DL1 itinerary, the price in (2) for the DL2 itinerary is less than the price in (2) for the DL1 itinerary. Likewise, while the price in (2) for the DL1 itinerary is greater than the price in (2) for the DL2 itinerary, the time amount in (1) for the DL1 itinerary is less than the time amount in (1) for the DL2 itinerary. Thus, in creating the group matrix, two labels for origin 1 (i.e., the AA2 and AA3 itineraries) and two labels for origin 2 (i.e., the DL1 and DL2 itineraries) may be used to create a group label for the 10:00 am time slot.

However, for the 11:00 am time slot both the DL1 and DL2 itineraries may be eliminated because the time amount in (1) for the DL3 itinerary is less than the time amount in (1) for either the DL1 or DL2 itineraries and the price in (2) for the DL3 itinerary is less than the price in (1) for either the DL1 or DL2 itineraries.

Thus, to create a group label for the 10:00 am time slot, the cross-product of the two labels for origin 1 and the two labels for origin 2 is determined by summing the times in (1) and the prices in (2) for the various combinations of itineraries from each origin. For example, four group labels may be created from the two labels for origin 1 and the two labels for origin 2 as follows:

| | |
|---|---|
| (1) | 150 + 90 = 240 |
| (2) | 130 + 120 = 250 |
| (3) | AA2/DL1 |
| (1) | 150 + 110 = 260 |
| (2) | 130 + 100 = 230 |
| (3) | AA2/DL2 |
| (1) | 0 + 90 = 90 |
| (2) | 200 + 120 = 320 |
| (3) | AA3/DL1 |
| (1) | 0 + 110 = 110 |
| (2) | 200 + 100 = 300 |
| (3) | AA3/DL2 |

Following the rules set forth above, none of these labels and associated itineraries may be eliminated. Thus, in the group matrix, four labels are included in the 10:00 am time slot (i.e., the AA2/DL1 itinerary, the AA2/DL2 itinerary, the AA3/DL1 itinerary, and the AA3/DL2 itinerary).

For the 11:00 am time slot, all of the labels from the 10:00 am time slot may transfer over with the only change being a 120 minute (i.e., the difference between 10:00 am and 11:00 am for each itinerary) addition to the time amounts in (1) of each of the labels, as shown below:

| | |
|---|---|
| (1) | 240 + 120 = 360 |
| (2) | 250 |
| (3) | AA2/DL1 |
| (1) | 260 + 120 = 380 |
| (2) | 230 |
| (3) | AA2/DL2 |
| (1) | 90 + 120 = 210 |
| (2) | 320 |
| (3) | AA3/DL1 |
| (1) | 110 + 120 = 230 |
| (2) | 300 |
| (3) | AA3/DL2 |

Alternatively, if the individual labels for itineraries from origin 2 were determined for an 11:00 am time slot, as shown above, and it is known that the DL3 itinerary eliminates the DL1 and DL2 itineraries for this time slot, then any group label that includes DL1 or DL2 may automatically be eliminated from the 11:00 am time slot for the group matrix. In either situation, the cross-product of the two labels for origin 1 and the DL3 label for origin 2 is determined by summing the times in (1) and the prices in (2) for the various combinations of itineraries from each origin. For example, two group labels may be created from the two labels for origin 1 and the one additional label for origin 2 as follows:

| | |
|---|---|
| (1) | 150 + 60 + 0 = 210 |
| (2) | 130 + 20 = 150 |
| (3) | AA2/DL3 |
| (1) | 0 + 60 + 0 = 60 |
| (2) | 200 + 20 = 220 |
| (3) | AA3/DL3 |

If the first four group labels (i.e., the AA2/DL1, AA2/DL2, AA3/DL1 and AA3/DL2 itineraries) were not automatically eliminated for the 11:00 am time slot as described above, then following the rules set forth above, the first four group labels may be eliminated at this point because both the time amounts in (1) and the prices in (2) for the AA2/DL3 and AA3/DL3 itineraries are less than the time amounts in (1) and the prices in (2) for the first four group labels. Thus, in the group matrix, two labels are included in the 11:00 am time slot (i.e., the AA2/DL3 itinerary and the AA3/DL3 itinerary).

This process continues until the outbound group matrix is populated for each arrival time slot for each itinerary (regardless of the origin). In addition, the same process described above is carried out to create a group matrix for inbound itineraries. In embodiments of the system 20 in which the outbound and inbound itineraries are tied to round-trip pricing that ties a particular outbound itinerary to a particular inbound itinerary, the itinerary labels and group labels may be created as described above, but an estimate, such as an average or mean of the price, use of the highest or lowest price, or any other type of estimate known to those skilled in the art, for each outbound itinerary over all of the possible inbound itineraries to which the outbound itinerary may be tied may be utilized in creating the labels. In the same way, an estimate or average of the price for each inbound itinerary over all of the possible outbound itineraries to which the inbound itinerary may be tied may be utilized in creating the labels. When presenting the prices of particular itineraries to the travel organizer and/or individual travelers, however, the exact pricing for the round trip is utilized. In other embodiments of the system 20, any type of computing known to those skilled in the art may be utilized to take into consideration the possible inbound itineraries when creating the labels for the outbound itineraries and to take into consideration the possible outbound itineraries when creating the labels for the inbound itineraries such that exact pricing is also utilized when creating the labels.

The inbound and outbound group matrices then may be searched by search engines, such as the Schedule Driven Search module 40 and the Price Driven Search module 46, to determine which group of itineraries best meets the group requirements indicated by the travel organizer. For example, if the travel organizer indicated that the schedule of the itineraries is weighted heavier than the price of the itineraries, such as by selecting “unrestricted” in the pricing option box 82, then the Schedule Driven Search module 40 searches the groups of itineraries for the group that has the least total waiting time in (1) of the labels. For the labels included in the group matrix described above, (i.e., the AA2/DL1, AA2/DL2, AA3/DL1 and AA3/DL2 itineraries for the 10:00 am time slot and the AA2/DL3 and AA3/DL3 itineraries for the 11:00 am time slot) the Schedule Driven Search module 40 would select AA3/DL3 itinerary in the 11:00 time slot because it has the smallest amount of time in (1) of the labels. If the travel organizer indicated that the price of the itineraries is weighted heavier than the schedule of the itineraries, such as by selecting “lowest available” from the pricing option box 82, then the Price Driven Search module 46 searches the groups of itineraries for the group that has the lowest total price in (2) of the labels. For the labels included in the group matrix described above, (i.e., the AA2/DL1, AA2/DL2, AA3/DL1 and AA3/DL2 itineraries for the 10:00 am time slot and the AA2/DL3 and AA3/DL3 itineraries for the 11:00 am time slot) the Price Driven Search module 46 would select AA2/DL3 itinerary in the 11:00 time slot because it has the lowest total price in (2) of the labels. Whichever group is chosen based upon the weighting the travel organizer indicated is then the suggested group of itineraries.

In other embodiments of the method and system 20 of the present invention, the travel organizer may select an intermediate weighting between price and schedule if an intermediate total waiting time and/or an intermediate total price is desired. For example, the pricing option box 82 may present one or more options that indicate an intermediate weighting between price and schedule is desired and the Schedule Driven Search module 40, the Price Driven Search module 46, combination of the Schedule Driven Search module 40 and the Price Driven Search module 46, or a separate intermediate search module may search the groups of itineraries for the group that most closely meets the desired weighting between schedule and price indicated by the travel organizer. To determine which group of itineraries most closely meets the desired weighting, the system 20 may normalize the differential in price and time of each group of itineraries as known to those skilled in the art. For instance, the differential in price and time of each group of itineraries for each arrival time slot may be determined as described above in creating the inbound and outbound group matrices. The differentials then may be scaled. The price portion of the scaled differentials then may be multiplied by the desired weighting of price, and the time portion of the scaled differentials may be multiplied by the desired weighting of the schedule. The weighted price and time portions then may be summed, and this number for each group of itineraries may be compared, such that the lowest number is associated with the group of itineraries that most closely meets the desired weighting between schedule and price indicated by the travel organizer.

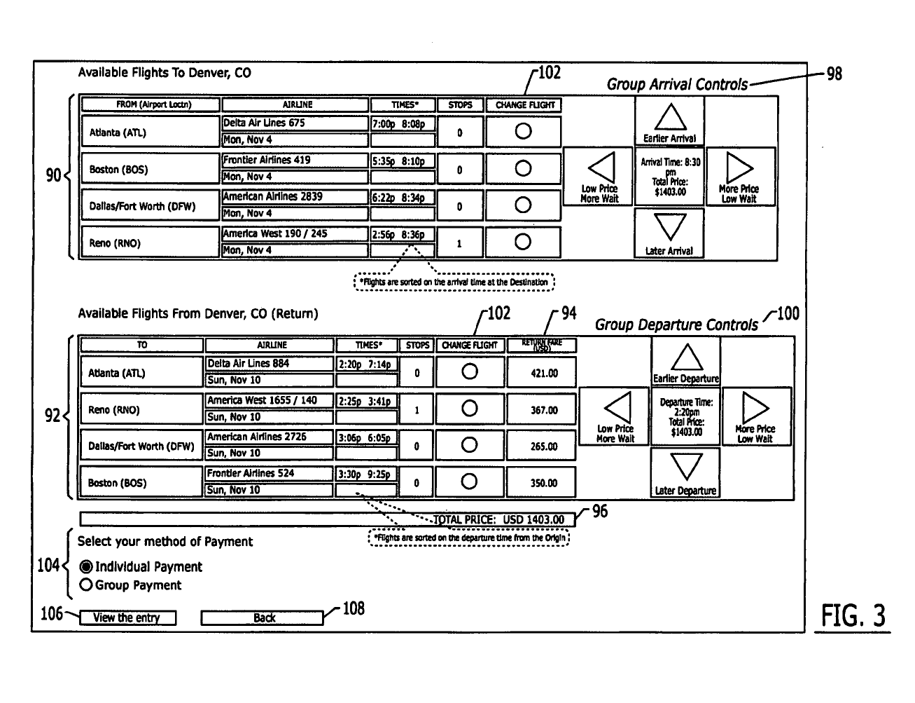

As illustrated in the embodiment of FIG. 3, the suggested group of itineraries is listed and displayed for the travel organizer to view. Thus, the processing element 24 transmits the information regarding the suggested group of itineraries to the client element(s) 22 via the network(s) 26. In this embodiment, the tables 90 and 92 are populated with the details of each outbound and inbound itinerary, respectively, from and to, respectively, each origin location. As shown in FIG. 3, the outbound group of itineraries may be sorted based upon the arrival times at the destination and the inbound group of itineraries may be sorted based upon the departure times from the destination. In addition, the individual prices for the each outbound and inbound itinerary for each origin is listed in column 94, and the total price for all of the itineraries from all of the origins is listed in box 96.

Modifications to the itineraries may be made in at least two ways. One way is by the group arrival controls 98 and/or the group departure controls 100. As such, for all of the inbound and/or outbound itineraries, changes may be made as a whole by way of the selection arrows or by other comparable controls. For example, regarding the embodiment of FIG. 3, if the “Earlier Arrival” or “Later Arrival” arrows are selected from the group arrival controls 98, then the processing element 24 accesses the stored group matrix of groups of itineraries to find a group, if any, in which the last traveler arrives the next closest time that is earlier than 8:36 pm or later than 8:36 pm, respectively. If the same arrow is selected again, then the group with the next closest time will be selected, and so on. If the “Low Price/More Wait” arrow is selected from the group arrival controls 98, then the processing element 24, particularly the Price Driven Search module 46, accesses the stored groups of itineraries to find a group, if any, that has the next lower price than the suggested group. If the “More Price/Low Wait” arrow is selected from the group arrival controls 98, then the processing element, particularly the Schedule Driven Search module 40, accesses the stored groups of itineraries to find a group, if any, that has the next lower total wait time than the suggested group. Once the desired group is found, then the processing element 24 transmits the information to the client element(s) 22 via the network(s) 26 to display the results.

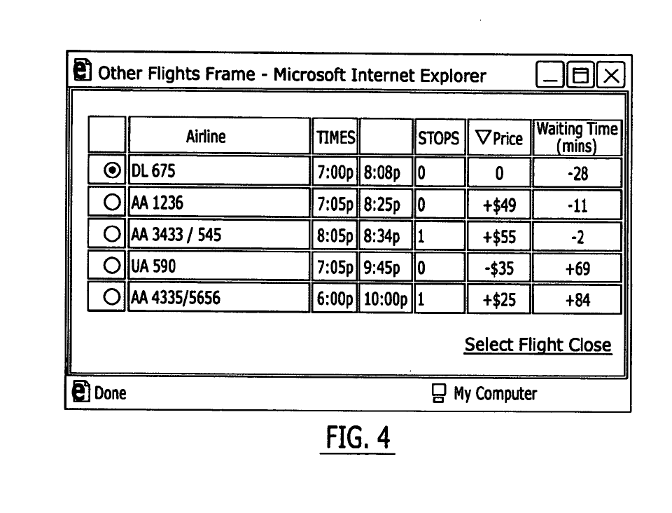

Another way to modify the suggested group of itineraries is to select the “Change Flight” button 102 associated with the individual inbound or outbound flight that is to be modified. For example, in the embodiment of FIG. 3, if the button 102 associated with the flight from Atlanta to Denver is selected, a request is transmitted to the processing element 24 to provide all of the identified itineraries from Atlanta to Denver. The processing element 24 accesses the matrix that contains all of the identified itineraries and extracts the Atlanta to Denver itineraries to transmit to the client element(s) 22 via the network 26. In addition, the Group Price/Schedule Sensor 42 recalculates each total price and total waiting time, and each change in total price and total waiting time, for the group of outbound itineraries with each identified itinerary, and this information is transmitted to the client element(s) 22 as well. Thus, FIG. 4 illustrates the display that a travel organizer and/or individual traveler views when all of the identified itineraries are presented. As shown in FIG. 4, the details of each identified itinerary are displayed along with the change in the price and the waiting time, which is based upon when the last person arrives at the destination. For example, the embodiment of FIG. 4 shows that by selecting the DL675 itinerary, the respective traveler would arrive at the destination 28 minutes prior to when the last traveler arrives at the destination. By selecting the AA 3433/545 itinerary, the traveler would arrive at the destination 2 minutes prior to when the last traveler arrives at the destination. Alternatively, by selecting the AA 4335/5656 itinerary, the respective traveler would become the last traveler to arrive at the destination, which would impose an additional waiting time of 84 minutes for all of the other travelers.

The travel organizer may also indicate the method of payment for the travel itineraries. As shown in FIG. 3, the travel organizer may select “Individual Payment” or “Group Payment” in options 104. If the “Individual Payment” option is selected, then each outbound and inbound itinerary is paid by the respective traveler, but if the “Group Payment” option is selected, then the travel organizer will be prompted to enter the payment information to pay for all of the outbound and inbound itineraries. Once the method of payment has been selected, the travel organizer may then select the “View Itinerary” box 106, which provides a display of a detailed list of all of the itineraries for all of the travelers. The travel organizer has the option to modify the individual itineraries of travelers from this display as well, such as by selecting a “Modify” indication associated with a particular itinerary. The identified itineraries may then be presented for the travel organizer to view, along with the changes to the overall price and waiting time that would result if a respective identified itinerary were selected, in the same way as described above regarding the “Change Flight” buttons 102. The travel organizer also may delete any traveler's itinerary at this point, such as by selecting a “Delete” indication.

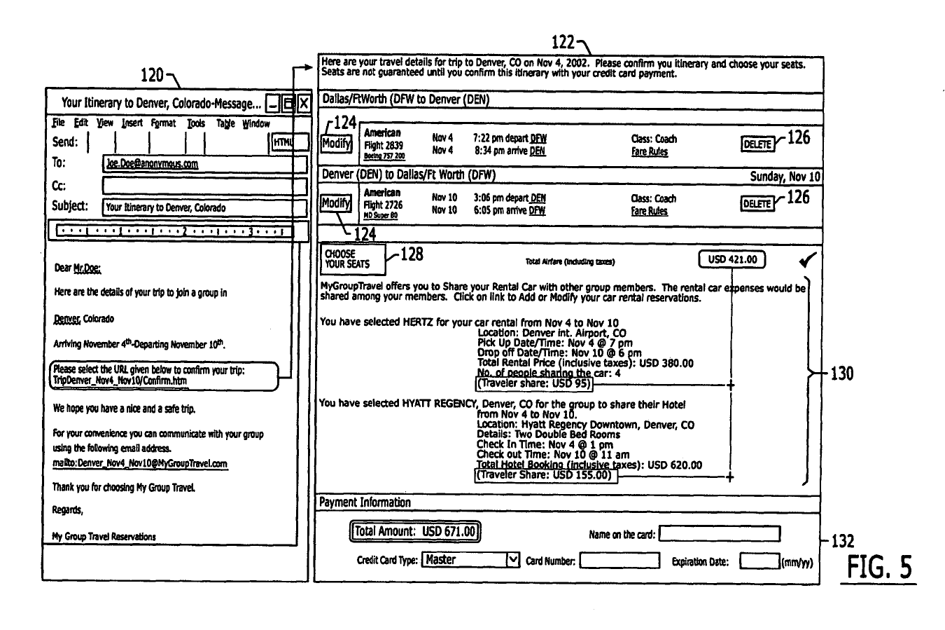

In addition, if any type of car rental or lodging options were selected by the travel organizer, the detailed itineraries associated with those rentals may be presented along with the travel itineraries. The travel organizer is also prompted to enter personal information regarding the specific travelers associated with each itinerary. For example, the travel organizer may be prompted to enter at least the names and email addresses of each traveler. By entering the email address of each traveler, the system 20 is capable of preparing and sending an email detailing each traveler's itinerary or containing a link to a web page that displays the itinerary information. In addition, the system 20 may create a group email address for each of the travelers and the travel organizer to facilitate communication between and/or among the travelers without having to distribute each traveler's personal information. An example of such an email is shown in FIG. 5, which is discussed further below.

If the group payment option was selected in the display shown in FIG. 3, then the travel organizer may be prompted to enter payment for the cost of all of the itineraries and any car rental or lodging rental. Furthermore, the travel organizer may be permitted to choose the seat assignments for the travelers, such as by selecting a “Choose Your Seats” indication. For example, the system 20 may access the seat assignment map associated with the respective itinerary by transmitting a request to the processing element 24. The processing element 24 then may obtain the seat assignment map from a database that stores the seat assignment map for the particular itinerary, such as a database that may be updated in real-time. Thus, the database is in communication with the processing element 24, such that the database may be part of the processing element 24 or part of any other element in communication with the processing element, such as the travel database 28. Once the seats associated with a particular itinerary are chosen, that information may be updated in the seat assignment map by transmitting the information to the database that may be updated in real-time, such as the travel database 28, via the processing element 24.

As discussed above, the system 20 is capable of preparing an email to each traveler that contains the details of the respective traveler's itinerary or a link to a web page that contains the details. Email 120 of FIG. 5 illustrates such a communication. This email contains a link to a web page that contains the details of the respective traveler's itinerary and the email communicates the group email address that permits each traveler and travel organizer to communicate with the rest of the travelers. When the traveler selects the link to the web page in the email, web page 122 may be displayed to the traveler. As discussed above with respect to the group payment option, the traveler may have the option to modify the itineraries by selecting the “Modify” box 124 or delete the itineraries by selecting the “Delete” box 126 associated with the respective itinerary in the same way the travel organizer could. In addition, the traveler may also be permitted to choose his seats by selecting the “Choose Your Seats” box 128 in the same way described above regarding the travel organizer. Any car rental or hotel rental information is also presented to the traveler via the web page 122 in portion 130. In some embodiments of the method and system 20, the traveler may also be permitted to modify the car rental and/or hotel rental information via the web page 122.

In the example of FIG. 5, the individual payment option was selected, such as by the travel organizer in FIG. 3, such that the car rental and hotel rental information also contains a statement of the respective traveler's share of those costs. Furthermore, because the individual payment option was selected, the web page 122 also contains portion 124 prompting the traveler to enter the payment information. Alternatively, if the individual payment options was not selected, but instead, the traveler's costs were paid under a group payment, which locked in the itineraries as selected by the travel organizer, the traveler may not have the option to modify or delete his itineraries.

Any other type of information may also be transmitted to the user, such as the travel organizer and/or the travelers, via the displays, such as those illustrated in FIGS. 3 and 5. For example, information associated with the destination location, such as advertisements for events or activities at the destination location, may be obtained from the processing element(s) 24 and/or the database 28, and may also be present to the user.

Thus, the method and system 20 for travel itinerary coordination provides accurate and fast techniques to coordinate the travel itineraries of multiple travelers from more than one origin location who are traveling to the same destination location. By permitting an indication of a relative weight between the itineraries schedule and price and options to modify any of the suggested itineraries with other identified itineraries, the method and system also provide flexibility and efficiency that was not possible by the prior art manual coordination techniques.

Some specific examples of implementations of the method and system 20 for travel itinerary coordination include both leisure and business travel. For example, a travel organizer may wish to coordinate the travel itineraries of multiple family members planning to travel to a family reunion from more than one origin location. Because each family member is paying for their own travel and are traveling on their own time, getting the lowest priced travel arrangements is relatively more important to the family members than minimizing the waiting time between the arrival and departure times of the travelers. Thus, utilizing the method and system 20 of the present invention, the travel coordinator can easily enter the trip and traveler information and receive the lowest priced travel itineraries that meet the trip criteria by indicating that the lowest available pricing is desired in the pricing option box 82. If, however, the travel itineraries that are suggested are not agreeable to the travel organizer, the travel organizer can search for alternate flights for one or more of the travelers or request a different group of suggested itineraries via the group travel controls, as illustrated by the example of FIG. 3. In addition, car rental and hotel rental information for the travelers may be coordinated at the same time, such that all of the travel and rental information is easily distributed to all of the family members and split among the family members who save money due to the coordination. The travel organizer can then permit distribution of the respective itineraries to the travelers who can then modify their itineraries, if desired, and pay for the travel individually, such as is illustrated in FIG. 5.

Another example is business travel, such as when a travel organizer is coordinating the travel itineraries of multiple employees planning to travel to a business meeting from more than one origin location. Because the business is paying for the travel costs of all of the travelers and because the travelers will be traveling on business time, minimizing the waiting time as much as possible is relatively more important to the business than the cost of the travel. The travel organizer may then indicate that the schedule is more important by selecting the unrestricted option from the pricing option box 82. If, however, the prices of the travel itineraries that are suggested are too expensive, the travel organizer can search for alternate flights for one or more of the travelers or request a different group of suggested itineraries via the group travel controls, as illustrated by the example of FIG. 3. In addition, the travel organizer can coordinate the car rental and/or hotel rental plans, such that all of the travel and rental information is easily distributed to all of the travelers and paid for by the business, which also saves money due to the coordination.

Event planning may also be easily coordinated via the trip itinerary coordination method and system 20 of the present invention. For example, a travel organizer may coordinate an event, such as a rafting trip, a tour, a sporting event, or any other type of activity, for multiple travelers from different origin locations. Thus, the event is scheduled to begin at a certain date and time, so the travel organizer can find the lowest available pricing or the closest arrival and departure time for the travel itineraries of all of the travelers based upon the indication the travel organizer enters into the pricing option box 82. If the suggested travel itineraries returned to the travel organizer are not satisfactory, then the travel organizer can also search for alternate flights for one or more of the travelers or request a different group of suggested itineraries via the group travel controls, as illustrated by the example of FIG. 3. In addition, the travel organizer can coordinate the car rental and/or hotel rental plans for the travelers, which may provide cost savings due to the coordination. The travel organizer also can select whether each traveler will pay for their own itineraries and other portions of the travel costs or whether one person will pay for all of the travel costs, as illustrated by FIG. 3. For example, the travel organizer may charge certain amounts for the event coordination as a whole or to each individual traveler, which would include each traveler's travel costs, such that the travel organizer pays for all of the travel costs. The travel organizer can then permit distribution of the respective itineraries to the travelers who can then modify their itineraries, if desired, such as is illustrated in FIG. 5.

Thus, there are many different applications in which the travel itinerary coordination method and system 20 could be utilized to coordinate the travel itineraries of multiple travelers, who are leaving from more than one origin location, but are arriving at the same destination location by providing automated techniques for determining which itineraries for each traveler best meets the specified criteria, such as the relative importance of the travel schedules versus the price, for the trip. A set of suggested travel itineraries that most closely meet the specified criteria are then provided, in addition to the amount of time between when any two travelers arrive at and/or leave from the destination location, and the price. Furthermore, the travel coordination techniques provide flexibility by allowing replacement of one or more of the suggested itineraries with other possible itineraries and recalculation of the time amounts and the price(s).

With respect to the time together method, FIG. 6 illustrates one embodiment of a set of general options and prompts that may be presented to a user of the time together method of the present invention via a client element 22. For example, in FIG. 6, a user, such as a travel organizer, is prompted via a client element 22 to enter one or more destination locations in the box 160 that follows the word “Destination:”, which is Miami, Fla. in this example. A user is further prompted to enter the origin locations for one or more of the travelers in the boxes 162a, 162b, wherein the provided example allows for a scenario where the travelers desire to go to Miami from two different origin locations, namely Reno, Nev. and Raleigh, N.C., in this example. One skilled in the art will appreciate, however, that the scenario illustrating two origin locations is for exemplary purposes only and is not intended to be limiting in this respect. For example, this initial data collection page on the client element 22 may be configured to have additional tabs for multiple origin location scenarios, besides the tabs for the “One Departure City” and the “Two Departure Cities” shown, or the initial data collection page may be provided with a prompt or a box (not shown) for allowing the user or travel organizer to select, such as with a mouse or other selection device associated with a client element 22, the appropriate amount of origin locations before the user is presented with the boxes for selecting, for instance, the origin location(s) and/or other travel data.

The user is also prompted to select the number and type, i.e., adults, children or seniors, of people that are traveling from each origin location in the boxes 164. For instance, in the example of FIG. 6, the user has indicated that 2 adults will be traveling from Reno, and 2 adults will be traveling from Raleigh. To enter the numbers in the boxes 164a, 164b, a user may select the box and utilize a keyboard associated with a client element 22 to enter the desired number in the box or select the arrow to the right of the box, such as with a mouse or other selection device associated with a client element 22, which may provide a list of all of the options for the numbers that may be entered into the box, then select the desired number from the list. Travelers intending to travel with children may indicate so by selecting the script 165a, 165b disposed adjacent to the respective box 164a, 164b for selecting the number of travelers. In instances where the system 20 may not make a distinction between the various types of travelers (i.e., no pricing differentiation between adults, seniors, and children), the script 165a, 165b may be used to explain the “no differentiation” policy to the user. The user, such as a travel organizer, may also be prompted to enter the class of travel for all or each of the travelers from each origin location though, in the present example, such an option has not been implemented. In any case, the selection of the travel class may be indicated/selected similarly to that described for the travel itinerary coordination method. Further, the user may be prompted to enter the desired dates for travel. Particularly, the user may enter the arrival and departure dates in the boxes 176, as shown in FIG. 6, in the same way as explained above with respect to boxes 162a, 162b, 164a, and 164b. Though not implemented in the provided example, in some instances, the user may be allowed to select particular preferred times for travel on the selected dates, and/or may be able to indicate whether the travelers are flexible concerning their travel dates or whether there are exact dates and/or times that the travelers wish to arrive at and/or depart from the selected destination. As previously discussed with respect to the travel itinerary coordination method, in some embodiments, the user may also be able to indicate the relative importance of the travel price to the travel schedule, though this feature is also not implemented in the present example.

One skilled in the art will appreciate that, in some embodiments of the time together methods and systems, the initial data collection page may be provided with certain logic that provides additional flexibility and/or efficiency of the search process. More particularly, in some instances, the user selection of the origin locations may be used by the system 20 to determine only those destinations available from those origin locations. This aspect may be implemented, for example, in situations with limited travel options or packages such as in “last-minute” travel arrangements where the system 20 only examines travel packages available with respect to the selected origin locations within the next week or two. For instance, in the illustrated example, should there be no travel packages (i.e., flight, hotel, and/or car) available to Ft. Lauderdale, Fla. from the selected origin locations (Reno and Raleigh) within 2 weeks of the inquiry made by the user, then Ft. Lauderdale, Fla. would not appear under the “Destination” box at the point of user selection. In this manner, the system 20 can be characterized as “predictive” since it may be configured to automatically show only those destination locations having travel package availability with respect to the selected origin locations.

In other instances, the time together methods and systems may also permit the user to conduct a more general search than a specific city and/or a specific date. More particularly, when selecting a destination, the user may just select a general destination (i.e., Florida, the Caribbean, or All Destinations) in the “Destination” box, without choosing a particular city. In this respect, the system 20 will return all results pertaining to the general destination. That is, for example, a general destination search for Florida may cause search results for all cities within Florida to be returned in response to the user query. More particularly, a general destination search for Florida may return suggestions, for instance, for Jacksonville, Orlando, Naples, Miami, Ft. Lauderdale, Key West, etc. Similarly, when selecting the travel dates, the user may more generally specify, for example, this weekend, next weekend, or all dates in the “Dates” box. Accordingly, the user would not have to determine particular dates of travel if the user only had weekend travel plans in mind upon conducting the query. The options described above are examples of general options that may be available to users of the system 20 on the initial data collection page of the client element 22, though other options may be added or the options may be combined in various combinations in other embodiments of the system 20 of the present invention. Accordingly, once the user has entered all of the information regarding the requested travel criteria and the travelers, the user may select the “search” box 186 to initiate a search by the system 20 for travel itineraries that best match the provided traveler information, with an emphasis on determining the time spent together by the travelers. The system 20 then initiates the search by requesting, from the travel database 28 and/or the external information feed 29, all of the travel itineraries that most closely meet the requirements entered by the user or the travel organizer. In transmitting any of the requests discussed herein, one request containing all of the travel information entered by the user may be transmitted to the database 28 and/or external information feed 29, or separate requests for each origin location or for each traveler may be transmitted to the database 28 and/or external information feed 29. The search may also involve the air scheduling engine 31.

The information entered by the user, such as the travel organizer, in FIG. 6 is thus transmitted to the processing element 24 that then communicates the information with the travel database 28 and/or the external information feed 29 in the form of one or more queries that may be manipulated by one or more of the scheduling engine 48, the availability engine 50, and the pricing engine 52. One particular embodiment of the time together method implemented via the system 20 is described hereinbelow, in which air travel itineraries are coordinated to determine a maximum time together for the travelers utilizing specific modules of the processing element 24, and in particular, the scheduling engine 48, and the database 28 and/or the external information feed 29. The present invention, however, is not limited to this embodiment of the time together method and may utilize other types of travel itineraries and other hardware and software known to those skilled in the art to accomplish the same results without departing from the spirit and scope of the present invention. For example, car rental and/or hotel rental may also be included in the time together method of the present invention by utilizing one or more application programs in the car selection engine 32 and/or the hotel selection engine 34, respectively, and the results thereof may factor into the suggested itineraries presented to the user, with respect to an optimized time together, as further discussed herein.

In the example of the embodiment of the system 20 illustrated by FIG. 6, the travel database 28 utilizes the scheduling engine 48 to identify all of the outbound and inbound itineraries between each origin and the destination that meet the travel dates and any other requirements as closely as possible. If more specific requirements were also entered by the travel organizer for one or more travelers, such as a specific airline or maximum number of connections, then the scheduling engine 48 also considers those requirements when identifying the itineraries. If, however, fewer than a minimum number of itineraries, or no itineraries, are identified that meet the requirements, particularly the selected travel dates, the scheduling engine 48 will identify other itineraries for different dates about the selected travel dates. For example, if no suitable itineraries are found for an arrival on Friday, September 23 and a departure on Monday September 26, the scheduling engine 48 may be configured to present alternative itineraries, for example, with an arrival date of Thursday, September 22 or Saturday, September 24, and/or a departure date of Sunday, September 25 or Tuesday, September 27. One skilled in the art will note, however, that alternate dates may be presented to the user regardless of itinerary availability, as discussed further herein, or, in other instances, the system 20 may be configured to not explore alternate dates if the user indicates that the travel plans of the travelers are inflexible. That is, in some embodiments, the system may be configured to address specific travel parameters of the user, where the user is not interested in alternate suggestions. In some instances, the scheduling engine 48 may access the external information feed 29 in order to, for example, verify itineraries or examine the syndicated calendars of the specified travelers to pare down the dates associated with the alternate itineraries or to find an alternate block of dates to the user. In addition, if travel requirements other than travel dates are indicated by the user, the scheduling engine 48 may, in some instances, consider various combinations of less than all of the travel requirements provided by the user. For example, if a particular traveler requires or prefers a specific airline and direct flights, but the scheduling engine 48 identifies no itineraries meeting those requirements on the selected travel dates, then the scheduling engine 48 will look to itineraries of other airlines and/or connecting flights that still meet the requested travel dates.

Once all of the outbound and inbound itineraries between each origin and the destination that meet the travel date requirements, or any other requirements, are identified, then the travel database 28 also obtains the availability of those itineraries from the availability engine 50 and/or the external information feed 29. For example, the availability engine 50 checks to determine whether each of the flights has one or more available seats for the traveler(s) and, in some instances, whether the availability is up to date via the external information feed 29. In addition, the availability engine 50 may check to determine whether each of the flights has seats available in the class of service specified for each traveler that may potentially book the flight. If one or more of the flights do not have any seats available, do not have enough seats available for all of the travelers that may potentially book the flight, or do not have the desired class of service seats available, then the respective itineraries may be flagged to indicate the lack of availability or the respective itineraries may be deleted from the list of itineraries that the scheduling engine 48 obtained. The prices of the identified itineraries may then be obtained in any conventional manner, and may be updated through communication via the external information feed 29. For instance, in the embodiment of FIG. 6, the pricing engine 52 of the database 28 provides one or more price matrices that include the prices for each inbound itinerary with any outbound itinerary and each outbound itinerary with any inbound itinerary. The price matrix or matrices are then transmitted to the Price Matrix Retriever 44 of the processing element 24. In some instances, particularly when only a certain amount of seats remain available for one or more of the flights, the availability engine 50 may be in communication with a system capable of indicating to the user the amount of seats that remain available in the particular seat class at an indicated price. Such a system is disclosed, for example, in U.S. patent application Ser. No. 10/981,375, filed Nov. 2, 2004, and entitled “Devices, Systems, and Methods for Providing Remaining Seat Availability Information in a Booking Class,” which is incorporated herein in its entirety by reference.

Once the available itineraries are determined for the specified travel dates, the system 20 may be further configured to sort the itineraries according to certain criteria, using at least one processing element 24, so as to provide the various itineraries to the user in an order corresponding to any user preferences. In one particular instance, the criteria is the maximum amount of time, given the travel dates selected by the user, that the travelers can spend together at the destination location. However, other criteria, in addition to the maximum time spent together, may also be considered in evaluating the various itineraries to determine an optimum amount of time together. For example, as detailed in the travel itinerary coordination method, the various itineraries may also be evaluated with respect to coordination of arrival and departure times for the various travelers, in addition to the time spent together. In this manner, given the selected travel dates, the itineraries having widely varying arrival and/or departure times for the various travelers may likely be moved lower on the list of suggested itineraries as compared to itineraries having all travelers arriving and departing within one or two hours of each other even though, for instance, the former itinerary may allow the travelers to spend a few more hours together. However, if the time together disparity is relatively large, the former itinerary may well be ranked over the latter itinerary (i.e., presuming the same departure times between the itineraries, the former itineraries having two parties arriving at the destination at 8 AM and 11 AM may be preferred over the latter itineraries having the two parties arriving at or close to 10 PM, because the former itineraries would allow the parties to have 11 more hours together at the destination location.

Accordingly, embodiments of the time together method of the present invention evaluate all possible itineraries meeting the requested travel dates and then evaluate particular parameters associated with the itineraries so as to determine a relative score for each itinerary. For example, the possible itineraries meeting the requested travel dates may be evaluated according to parameters including the actual travel time (to and/or from the destination location), any wait or layover time (that is, wait time may also include the time that one or more of the travelers has to wait for other travelers to arrive, or to depart after other travelers), the price of the itinerary, and/or the amount of time spent together by the travelers at the destination location. The time together parameter may be, for example, based on or related to the amount of time between the arrival of the last of the travelers at the destination location and the departure of the first of the travelers from the destination location for the travel dates selected by the user.

The evaluation parameters may be considered through a weighting formula premised on a concept of applying a dollar or monetary value to the time components of the evaluation parameters (e.g. time is money). In such a manner, each of the evaluation parameters may be assigned a “conversion rate” or weighting factor that can be adjusted as appropriate. For example, each 1 minute of wait or layover time can be valued as (cost) $1.00, each 1 minute of time together can be valued as (benefit) −$2.00, the cost of the particular itinerary can be carried as the dollar value thereof, while the actual travel time may also be assigned a cost per minute (i.e., $1.00). As such, depending on the weighting factor assigned to each evaluation parameter, the score for each itinerary will vary. Thus, in terms of the “cost” weighting procedure in this instance, the system 20 determines the itineraries with the lowest scores (“least cost”) and may then present a certain amount of these itineraries to the user as suggested itineraries. In some instances, however, qualitative criteria may be applied to all of the possible itineraries in addition to, or in the alternative to, the weighting process for the evaluation parameters. For example, such qualitative criteria may include, for example, the cheapest itinerary, the itinerary with absolutely the most time together, the itinerary with the best schedule for the travelers to “avoid taking PTO time,” or any other suitable criteria. Such qualitative criteria may be indicated by the user on the initial data collection page of the client element 22, or the user may be presented with opportunities to filter the itineraries presented by the system 20 in response to the user query. An optimum time together for the travelers may thus be determined by application of the weighting procedure and/or the qualitative criteria.

All of the identified itineraries and their prices returned in response to the user's query may be stored in the processing element 24 and/or in a storage element in communication with the processing element 24, such that the system 20 does not have to access the travel database 28, if the travel organizer and/or any of the travelers desire to modify sorting or preferences, modify the relative weight assignment between schedule and price, or view all of the identified itineraries.

In some instances, the system 20 may also be configured to present product and/or service options to the user, that are related to the results of the user query, via an affinity procedure or algorithm. For example, in the scenario provided above using Miami, Fla. as the destination location (i.e., typically a beach destination), the affinity procedure may be applied to the user's query to return itineraries directed to other destinations known for its beaches. For instance, Fort Lauderdale, Fla. may be provided as one alternative beach itinerary. In this regard, the affinity procedure may provide many different suggested alternative itineraries with regard to the destination queried by the user. For example, the affinity procedure may provide suggestions in terms of various attributes such as mood, theme, event, geography, or the like, wherein such suggestions may be determined and provided by the system 20, or selected by the user. In the alternative, the system 20 may implement an extrapolative procedure or algorithm using logic and/or user input to extrapolate alternative suggested itineraries on the basis of, for instance, alternate dates, nearby destinations, regional destinations, or destinations determined along a particular theme. Such an affinity procedure and an extrapolative procedure are disclosed, for example, in commonly-owned U.S. patent application entitled “SYSTEM, METHODS AND COMPUTER PROGRAM PRODUCTS FOR OFFERING PRODUCTS BASED ON EXTRAPOLATION OF INPUT,” filed Aug. 30, 2005, which is incorporated herein in its entirety by reference.

Commonly-owned U.S. patent application entitled “SYSTEM, METHODS AND COMPUTER PROGRAM PRODUCTS FOR OFFERING PRODUCTS BASED ON EXTRAPOLATION OF INPUT,” filed Aug. 30, 2005, also discloses that the results returned by the affinity procedure and/or the extrapolative procedure may, in some instances, be numerically limited by a truncation procedure showing a preference or applying a criteria, for example, for more popular packages, packages better fitting the affinity procedure or the extrapolative procedure, elimination of duplicate results, less expensive packages, or the like. As such, a system 20 as disclosed herein may also be configured to implement such truncation or “pruning” procedures, as necessary, to provide only selected results to the user, in order to avoid overloading the user with excessive information. Of course, one skilled in the art will appreciate that the system 20 may provide appropriate functionality and provisions for allowing the user to view all search results at any time. That is, if desired by the user, the user can, in some instances, request to see all results for any particular aspect of the search. For example, the user may be able to request to see all available flight packages (sets of suggested outbound and inbound itineraries), all nearby destination suggestions, or the like.

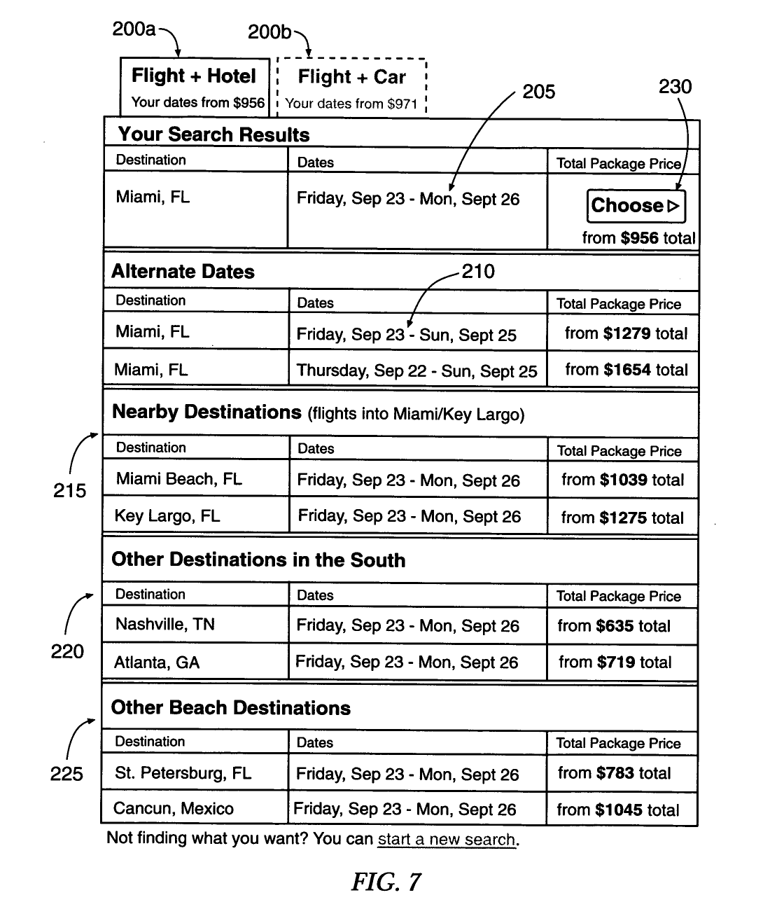

According to further aspects of the present invention, the system 20 may be configured to provide transportation-only itineraries or, in some instances, the transportation itineraries may be packaged with accommodation (hotel) and/or rental car offers at the destination location. That is, the itineraries presented to the user, in response to the user query, may also take into consideration the availability of various hotel and/or rental car options (as determine by the car selection engine 32 and/or the hotel selection engine 34, in conjunction with the database 28 and/or the external information feed 29), as particularly packaged with the travel itineraries, as shown in FIG. 7. One skilled in the art will appreciate that, in some instances, depending, or example, on marketing or other business arrangements between various entities, that a package of transportation plus accommodations, transportation plus rental car, transportation plus accommodations plus rental car, and/or transportation plus transportation (i.e., a combination of flights, a combination of flights, rail, and/or ship for touring Europe) may be more attractively priced than any of such elements priced separately. Accordingly, embodiments of the methods and systems of the present invention, particularly the time together method, may, in some instances, be directed specifically to packages of various combinations of these elements. With regard to the system 20, such packages may be determined, for example, by a package pricing engine 33 forming a component of the processing element 24, as shown in FIG. 1. In such instances, the package pricing engine 33 may be configured to access a database or other information source, such as the database 28 and/or the external information feed 29, and to form various package combinations based on, for example, the user-specified origin location, destination location, and travel dates. In forming the various package combinations, the package pricing engine 33 may cooperate with any of the air scheduling engine 31, the car selection engine 32, and the hotel selection engine 34, as necessary. One skilled in the art will also appreciate, however, that the system 20 may sometimes require more or less information from the user when forming such packages via the package pricing engine 33. In such cases, should the system 20 determine that a large amount of packages are available for the user-selected origin location, destination location, and travel dates, the system 20 may then implement various mechanisms to reduce, “prune,” or otherwise simplify the results presented to the user. For example, the initial data collection page may be configured prompt the user to enter additional information to provide narrower search results, affinity and/or extrapolation procedures may be implemented to categorize the results for further user selection, or the user may be provided with various sorting capabilities and/or filters to browse through all of the package results.

In some instances, prices of such packages may be even more attractive where in “last minute” situations where providers seek to fill availability such that the available products and/or services do not go unused. Accordingly, embodiments of the methods and systems of the present invention may, in some instances, be more effectively marketed as “last minute” specials such as, for instance, available within the next fourteen days. Further, one skilled in the art will appreciate that, although examples are presented herein in terms of the transportation comprising air travel (i.e., flights), the methods and systems of the present invention may be equally applicable to other form of transportation such as rail or ship. As such, any examples presented herein are not intended to be limiting in any manner. In addition, one skilled in the art will also appreciate that any suggestions presented to the user by the system 20, whether by transportation itinerary alone or by some combination package, may further include, in some instances, suggestions, offers, and/or free inclusion of “travel extras” or other features associated with the destination location. For example, such travel extras may include tickets to cultural or sporting events, reservations and/or coupons to suggested restaurants, directions to shopping opportunities with recommended merchants, or tickets to local attractions at the destination location. With regard to the system 20, such travel extras may be determined, for example, by a travel extras engine 35 forming a component of the processing element 24, as shown in FIG. 1. In such instances, the travel extras engine 35 may be configured to access a database or other information source, such as the database 28 and/or the external information feed 29, and to determine various travel extras specific to the destination location and/or the travel dates. In forming the various travel extras suggestions, the travel extras engine 35 may cooperate with any of the air scheduling engine 31, the car selection engine 32, and the hotel selection engine 34, as necessary. For example, should a “must see” event be occurring somewhere about the selected destination location during the specified travel dates, the travel extras engine may combine ticket offers with rental car specials to attend the event (determined via the car selection engine 32) and/or parking and/or accommodations at the event site (determined via the hotel selection engine 34). One skilled in the art will appreciate, however, that the concept of travel extras includes a myriad of possible applications in addition to the examples presented herein. For instance, such travel extras may be used in conjunction with affinity and/or extrapolation procedures to steer a user, or to gather more information with respect to the user's interests so as to provide better suggestions to the user. In other cases, particular travel extra suggestions or categories of such suggestions, may also be provided on the initial data collection page to provide possible destination location to the user prior to the user entering any travel preferences. Again, the examples of such “travel extras,” or the functionality or applications thereof as presented herein, are not intended to be limiting in any manner.

The results initially presented to the user at the client element 22 in response to the user query may be placed into groups, sub-group, or otherwise sorted in a categorical manner to provide a summary of the available options. As shown in FIG. 7, such a summary may include, for example, groups arranged according to travel dates; by class of travel, hotel, and/or rental car; the price of the particular package; or any particular attributes provided by an affinity and/or extrapolation procedure (alternate dates, nearby destinations, other destinations in the geographic region, or other destinations having a particular attribute). In one embodiment, a limited number of subgroups, or choices in each group, are presented to the user for further selection prior to presenting the specific itineraries determined by the system 20. The choices within each group can be displayed according to, for example, price, arrival time at the destination location, travel time, or time together (the actual magnitude of the time together or the optimum amount of time together given the other travel parameters selected by the user), wherein the user in then able to select a particular choice that may have a certain user-preferred attribute so as to view the set(s) of itineraries associated therewith. As previously discussed, the groups, subgroups, and/or choices presented to the user, as shown in FIG. 7 may be the result of an affinity procedure and/or an extrapolation procedure (possibly as well as a truncation or pruning procedure) applied to the search results prior to the presentation to the user.

As further shown in FIG. 7, the results according to one aspect of the invention may be separated into two separate tabs 200a, 200b identifying, for example, flight plus hotel itineraries (packages) and flight plus car itineraries (packages). In either instance, regardless of the tab 200a, 200b selected by the user, the user may be later presented with a choice of hotel or car associated with the non-selected tab such that, if desired, the user can select a package of flight plus hotel plus car. That is, either of the option tabs 200a, 200b presented to the user may further include, in some instances, functionality to allow the user to select the non-selected option of the other tab (i.e., hotel or car, as appropriate). FIG. 7 particularly shows the flight plus hotel tab 200a as the operable tab, thereby allowing the user to select from itineraries based on the actual dates 205 specified by the user, itineraries based on alternate dates 210 determined by the system 20, or other suggested destinations 215, 220, 225 determined by the system 20. The user may be able to make a selection through a dedicated box, such a “choose” box 230, or through link-enabled script. For example, the alternate travel dates under the “Alternate Dates” group or the alternate destinations under the various destination groups, may be link-enabled as an indication of the user's selection, but may also indicate a particular attribute-of-interest of the user to the system 20. For example, a user selection of one of the alternate beach destinations may indicate, to the system 20 and/or an affinity or extrapolation procedure, the scope of the user's interest. More particularly, selecting St. Petersburg, Fla. may indicate to the system 20 that the user is interested in domestic beach locations in Florida, while selecting Cancun, Mexico may indicate to the system 20 that the user is interested in foreign beach locations or any beach locations having a “party” atmosphere or mood. As a result, the system 20 may be configured to subsequently provide such results with such attributes to the user, prior to the user making a final selection of a particular itinerary and destination.

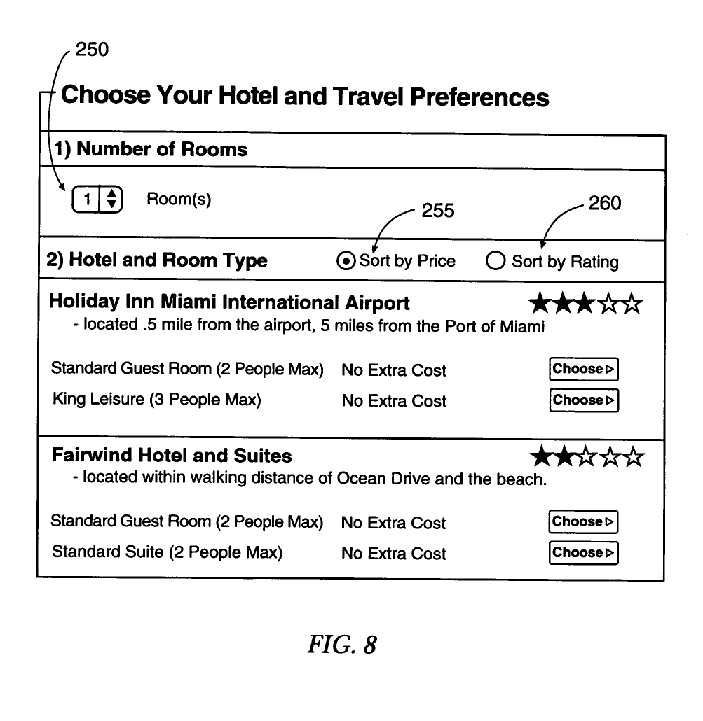

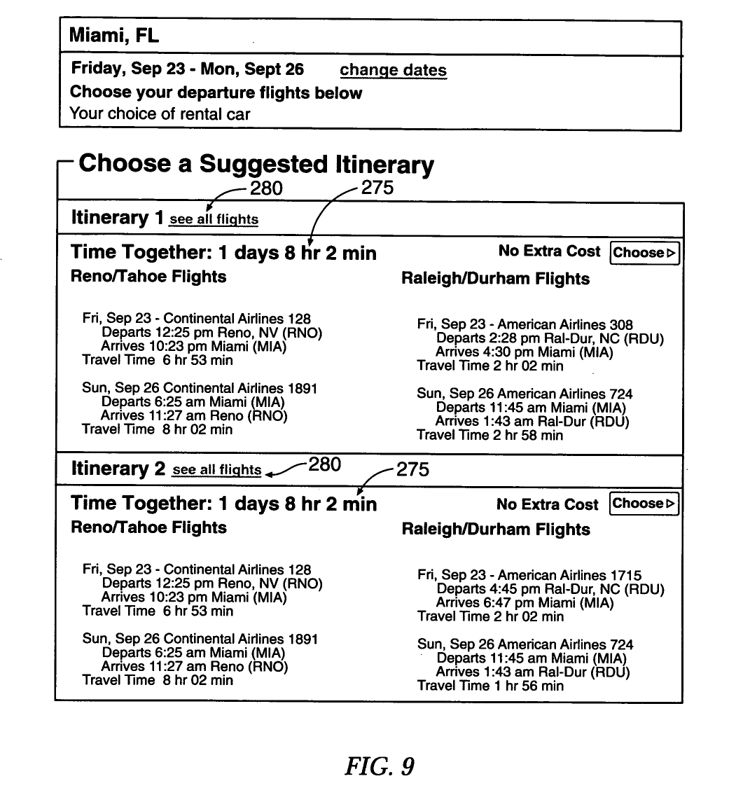

If the user proceeds under the flight plus hotel tab 200a, a user selection of a suggested sub-group or choice then causes the user to be presented with the various hotel options associated with that choice, as shown in FIG. 8. As will be appreciated by one skilled in the art, the hotel selection page may allow the user to select the number of rooms 250 and to list the options by, for example, price 255 or rating 260, with each hotel option showing the various room types or classes (and associated cost or additional cost over a base cost for the particular itinerary) available for the user's query. Once the user performs the hotel selection, the user is presented with the various flight itineraries corresponding to the user selection of a suggested sub-group or choice under the flight plus hotel tab 200a. As shown in FIG. 9, the user is presented with the selected destination location and travel dates, and may be presented with further options for selecting a car or changing the travel dates. The various sets of itineraries are also presented, providing details of the flights to and from the destination location with respect to each of the origin locations, along with the associated travel times. According to one advantageous aspect of the present invention and in any instance, each itinerary presented to the user includes an indication of the time spent together 275 by the travelers at the destination location for that itinerary. Each flight itinerary is provide with an indication of any additional cost over the base cost, wherein such additional cost may be associated with, for example, the various flights or the class of the available seats on a particular flight.

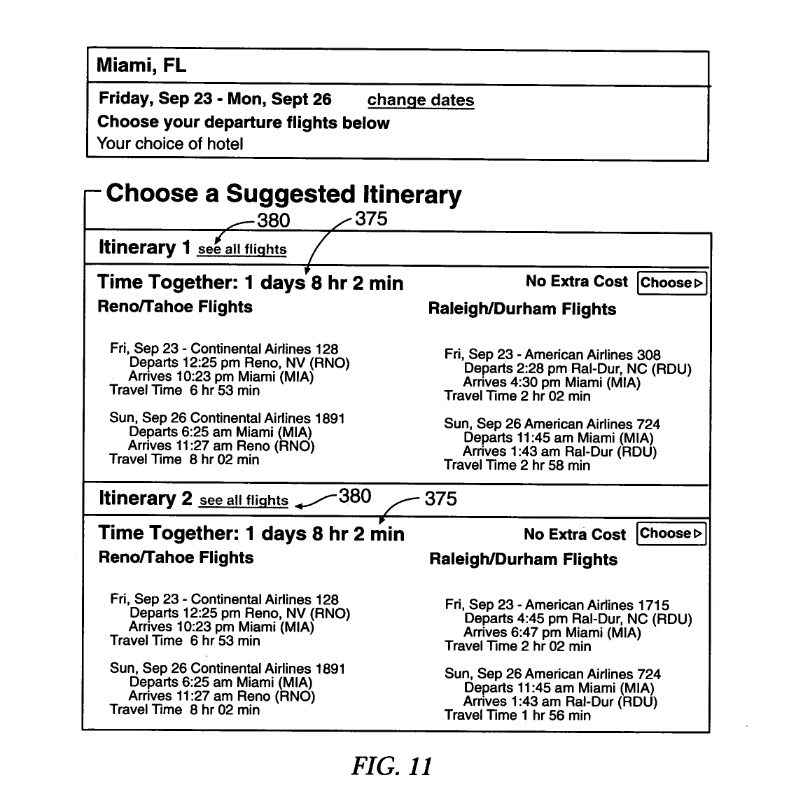

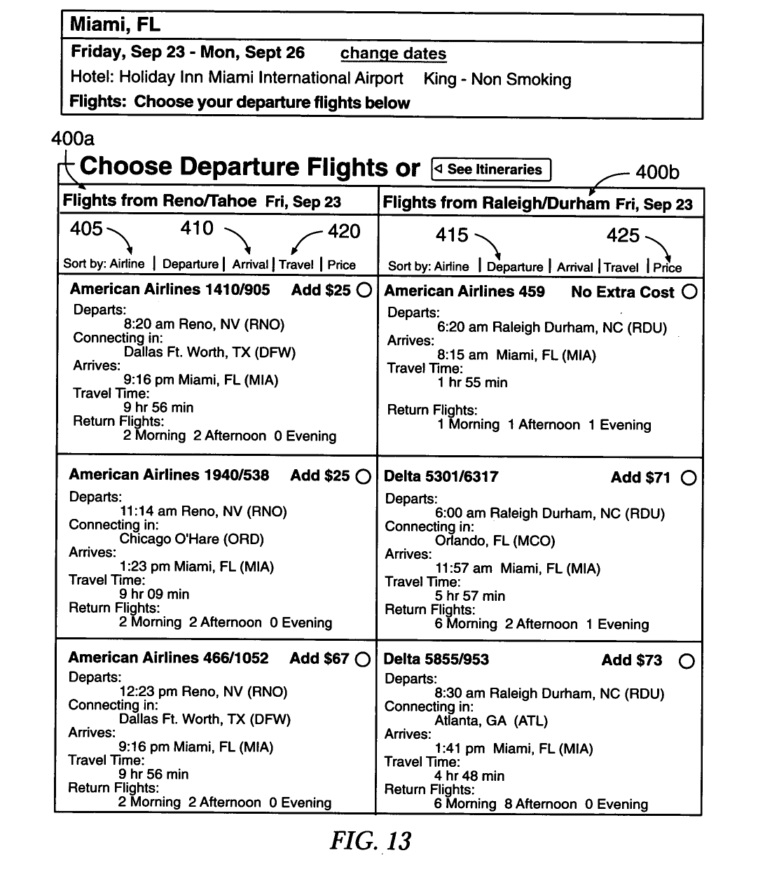

In some instances, the user may be presented with the option of examining all flight itineraries returned from the search. For instance, by selecting the “See All Flights” script 280 (see, e.g., FIG. 9), 380 (see, e.g., FIG. 11), the user may then be presented with a listing of all itineraries, arranged according to origin location. That is, for example, the user may be presented in some instances with side-by-side columns listing the itineraries associated with the respective origin locations. More particularly, as shown in FIG. 13, the user may be presented with the flight itinerary options originating from Reno in the left-side column 400a, while the flight itinerary options originating from Raleigh are presented in the right-side column 400b. One skilled in the art will appreciate, however, that the number of columns presented to the user may increase or decrease, as necessary in response to the number of origin locations entered by the user. Further, one skilled in the art will appreciate that the flight itinerary results sorted by origin location may be presented to the user in many different manners besides being in side-by-side columns. For example, the origin locations may be presented as row headings whereby the lists of corresponding flight itineraries could be presented in a scrollable box besides the corresponding row heading. Accordingly, the examples presented herein regarding the presentation of all search results in a particular field are not intended to be limiting in any manner.

Further to all flight itinerary options being presented to the user as arranged according to origin location, the time together systems and methods may further allow the flight itinerary options under each origin location heading to be sorted according to an attribute of the itineraries, separately, discretely, or independently of the other flight itinerary options under the other origin location headings. Such attributes may include, for example, a particular or selected airline 405, an arrival time 410 with respect to the destination location, a departure time 415 with respect to the destination location, a total travel time 420, an amount of stops between the origin location and the destination location, and a cost or price 425 of the particular itinerary option. As such, for example, the flight itinerary options originating from Reno may be sorted by the user according to a total travel time attribute 420 (i.e., the flight itinerary options be sorted according to increasing total travel times since, for instance, the Reno travelers may be interested in the shortest travel time to get to Miami), while the flight itinerary options originating from Raleigh may be sorted by the user according to the price or cost attribute 425 (i.e., the travel duration from Raleigh to Miami is relatively short, so the user may be interested in, for instance, the cheapest airfare for that trip). With all of the flight itinerary options being presented to the user in this manner, the system may further divide the flight itinerary options into outbound flights and inbound flights (not shown). That is, upon selecting the “See All Flights” script 280, the user may be first presented with all of the outbound (i.e., origin location to destination location) itineraries under the various origin location headings. Upon sorting and selecting the particular outbound flights from one or more of the origin locations (the user may choose to leave untouched the system-selected itinerary option for any of the itineraries), the user is then presented with all of the inbound (i.e., destination location to origin location) itineraries under the same origin location headings. Upon sorting and selecting the particular inbound flights to one or more of the origin locations, the user is then presented with the revised set of itineraries from the selected origin locations to the selected destination location, along with a recalculated cost, travel time, time together, or any other appropriate information for the newly-selected set of itineraries.

One skilled in the art will also appreciate that other information may also be presented for each flight itinerary option, whether outbound or inbound, for presentation to the user. More particularly, outbound itineraries may include, for example, the cost (or additional cost) associated with that itinerary selection, the departure time, the arrival time, the number of stops (or connections), the total travel time, and/or the number of available inbound itinerary options available for that outbound itinerary selection. Once the outbound itinerary(ies) are selected, the available inbound itineraries may present similar information for each itinerary, except perhaps a number of outbound itineraries available for that inbound itinerary selection.

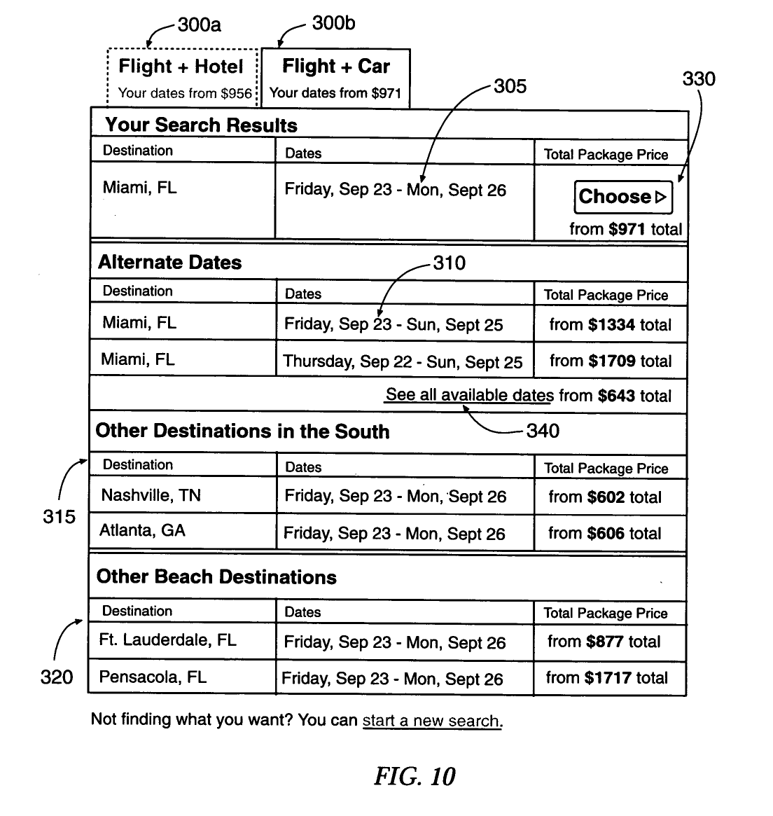

Should the user select the flight plus car tab 200b, shown in FIG. 7, the user is presented with results similar to those shown in FIG. 7. As shown in FIG. 10, the user can thereby select, under the flight plus car tab 200b, from itineraries based on the actual dates 305 specified by the user, itineraries based on alternate dates 310 determined by the system 20, or other suggested destinations 315, 320 determined by the system 20. As before, the user may be able to make a selection through a dedicated box, such a “choose” box 330, or through link-enabled script. In some instances, the user may be able to examine all results for a particular aspect of the search such as, for example, options for “all available dates” 340 under the “Alternate Dates” group. User selection of a suggested sub-group or choice then causes the user to be presented with the various flight itineraries corresponding to the user selection of a suggested sub-group or choice under the flight plus car tab 200b. As shown in FIG. 11, the user is presented with the selected destination location and travel dates, and may be presented with further options for selecting a hotel or changing the travel dates. The various sets of itineraries are also presented, providing details of the flights to and from the destination location with respect to each of the origin locations, along with the associated travel times. In any instance, each itinerary presented to the user includes an indication of the time spent together 375 by the travelers at the destination location for that itinerary. Each flight itinerary is also provide with an indication of any additional cost over the base cost, wherein such additional cost may be associated with, for example, the various flights or the class of the available seats on a particular flight. As previously discussed, in some instances, the user may be presented with the option of examining all flight itineraries returned from the search, under the “See All Flights” script 280 and selecting alternate flight itineraries, as appropriate.

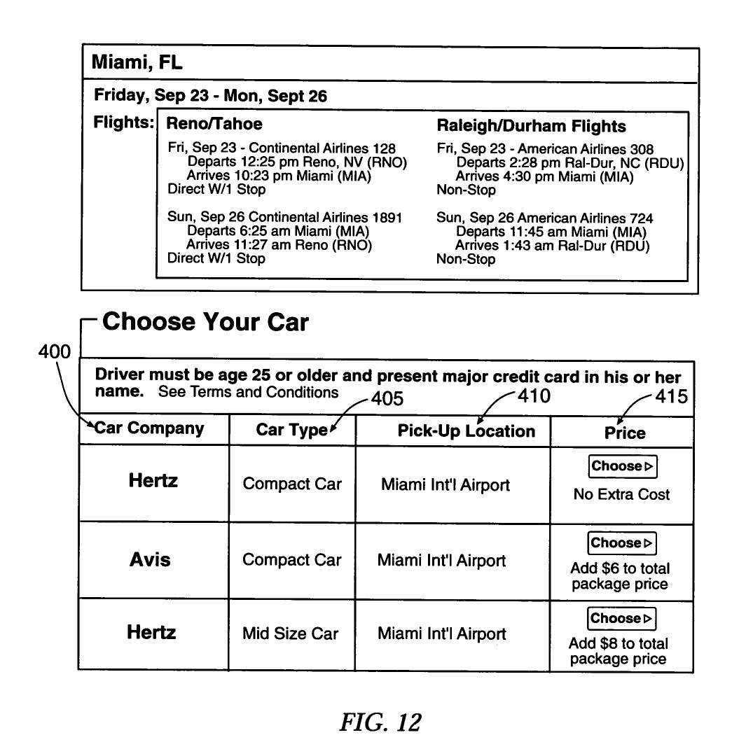

A user selection of a suggested flight itinerary then causes the user to be presented with the various rental car options associated with that choice, as shown in FIG. 12. As will be appreciated by one skilled in the art, the car selection page may show the flight itinerary selected by the user, and allows the user to select, for example, a particular rental car company 400, the type or class of car 405, and the pick-up location 410. Each presented option also provides the user with an indication of the associated cost of the car rental or the additional cost of the rental car over a base cost for the particular itinerary 415.

One skilled in the art will appreciate that, under the time together method, various functions and/or functionalities may also be implemented as previously discussed with respect to the travel itinerary coordination method. Such functions and/or functionalities may include, for example, the ability of the user to change particular flight plans in an itinerary using a “Change Flight” or “See All Flights” button, or to choose the seat assignments for the travelers, such as by selecting a “Choose Your Seats” indicator. The user or travel organizer may also indicate the method of payment for the travel itineraries, such as “Individual Payment” or “Group Payment,” and may further be presented with the ability to view the overall itinerary through, for example, a “View Itinerary” box which provides a display of a detailed list of all of the itineraries for all of the travelers. Upon being presented with the itineraries, the user may also have the option to modify the individual itineraries of any of the travelers, or to delete any traveler's itinerary, as appropriate, wherein various results (i.e., time together, package price, etc.) may then be recalculated, if desired. Similar procedures for the hotel and rental car selections may also be used, such as the requirement for personal information and communication of the various itineraries through email for allowing the system 20 to prepare and send an email to each traveler detailing the respective traveler's itinerary or containing a link to a web page that displays that itinerary information. In addition, the system 20 may create a group email address for each of the travelers and the travel organizer to facilitate communication between and/or among the travelers without having to distribute each traveler's personal information. A statement of the respective traveler's share of those costs (i.e., a per traveler or per origin location cost breakdown) may also be available, as well as different payment information options. In addition, information associated with the destination location, such as advertisements for events or activities at the destination location, may be obtained from the processing element(s) 24 and/or the database 28, and may also be present to the user.

Thus, the time together method provides accurate and fast techniques for coordinate the travel itineraries of multiple travelers from more than one origin location who are traveling to the same destination location so as to allow the travelers to make itinerary selection based on the amount of time spent together at the destination location. By providing a comprehensive system 20 also provides flexibility and efficiency that was not possible by the prior art manual coordination techniques by using automated techniques for determining which itineraries for each traveler best meets the specified criteria for optimizing the time spent together for the trip.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for coordinating outbound and inbound itineraries for a plurality of travelers, comprising:
receiving a destination location, a plurality of origin locations, and travel information, each origin location being associated with at least one traveler; and
determining a set of suggested outbound and inbound itineraries between each origin location and the destination location, based upon the travel information, from a travel database comprising at least outbound and inbound itineraries between the origin locations and the destination location, each suggested outbound and inbound itinerary comprising an arrival time and a departure time with respect to the destination location, and the set of suggested outbound and inbound itineraries collectively providing an optimal time together of the travelers at the destination location.

2. A method according to claim 1 further comprising determining an actual time together of the travelers as a difference between a latest arrival time of the travelers at the destination location and an earliest departure time the travelers from the destination location, from the set of suggested outbound and inbound itineraries of the travelers.

3. A method according to claim 2 further comprising determining a total arrival wait time as a sum of differences between the latest arrival time and each arrival time for the set of suggested outbound and inbound itineraries, and a total departure wait time as a sum of differences between each departure time for the set of suggested outbound and inbound itineraries and the earliest departure time.

4. A method according to claim 3 further comprising determining an actual travel time and any layover time for each of the set of suggested outbound and inbound itineraries, a sum of the total arrival wait time, the total departure wait time, and any layover times comprising a total wait time, and a sum of the actual travel times comprising a total travel time.

5. A method according to claim 4 further comprising determining a cost for each of the set of suggested outbound and inbound itineraries, a sum of the costs comprising a total cost.

6. A method according to claim 5 further comprising determining, for the set of suggested outbound and inbound itineraries, a weighted average of the actual time together, the total wait time, the total travel time, and the total cost, the weighted average being associated with the optimal time together of the travelers at the destination location.

7. A method according to claim 6 further comprising comparing the weighted average for one set of suggested outbound and inbound itineraries to the weighted average of at least one other set of suggested outbound and inbound itineraries so as to determine the optimal time together of the travelers at the destination location.

8. A method according to claim 6, wherein determining a weighted average further comprises assigning a monetary cost factor to each of the total wait time, the total travel time, and the total cost, and assigning a monetary benefit factor to the actual time together, the monetary benefit factor having a greater absolute value than the monetary cost factor.

9. A method according to claim 1 further comprising identifying an alternate set of suggested outbound and inbound itineraries by applying a qualitative criteria to the outbound and inbound itineraries in the travel database, the qualitative criteria being at least one of a lowest cost, a maximum time together, and proximately-grouped arrival and departure times.

10. A method according to claim 1 further comprising receiving an indication of a relative weight between price and schedule for at least one of the set of outbound and inbound itineraries, wherein determining a set of suggested outbound and inbound itineraries further comprises determining a set of suggested outbound and inbound itineraries at least partially based upon the indication of the relative weight, from the travel database of the outbound and inbound itineraries between each origin location and the destination location.

11. A method according to claim 1 further comprising:
presenting at least the set of suggested outbound and inbound itineraries for review;
receiving an indication that alternative itineraries are desired for at least one of the outbound and inbound itineraries associated with one of the travelers in the set of suggested outbound and inbound itineraries;
presenting at least one other suggested outbound and inbound itinerary between the destination location and an origin location for review in response to the received indication;
receiving an indication of a selection of one of the at least one other suggested outbound and inbound itinerary; and
modifying the set of the suggested outbound and inbound itineraries to include the selected one of the at least one other suggested outbound and inbound itinerary.

12. A method according to claim 11 further comprising presenting information associated with at least one of the destination location, a hotel at the destination location, and a rental vehicle at the destination location, in conjunction with presenting at least the set of suggested outbound and inbound itineraries for review.

13. A method according to claim 11 further comprising:
receiving hotel rental requirements associated with at least one of the travelers;
identifying at least one hotel itinerary, from hotel rental information for the destination location in a travel database, based upon the hotel rental requirements;
presenting the identified at least one hotel itinerary for review; and
receiving an indication of a selected hotel itinerary from the identified at least one hotel itinerary.

14. A method according to claim 11 further comprising:
receiving car rental requirements associated with at least one of the travelers;
identifying at least one car rental itinerary, from car rental information for the destination location in a travel database, based upon the car rental requirements;
presenting the identified at least one car rental itinerary for review; and
receiving an indication of a selected car rental itinerary from the identified at least one car rental itinerary.

15. A method according to claim 1 wherein receiving travel information further comprises receiving travel information regarding at least one of the travelers via at least one of a push-type syndicated information source and a pull-type syndicated information retrieval system.

16. A method according to claim 1 wherein determining a set of suggested outbound and inbound itineraries between each origin location and the destination location, based upon the travel information, from a travel database further comprises determining a plurality of sets of suggested outbound and inbound itineraries between each origin location and the destination location, based upon the travel information, from a travel database using one of an affinity procedure and an extrapolation procedure.

17. A method according to claim 16 further comprising limiting the plurality of sets of suggested outbound and inbound itineraries between each origin location and the destination location, by applying a pruning procedure thereto.

18. A system for coordinating outbound and inbound itineraries for a plurality of travelers, comprising:
at least one client element capable of receiving a destination location, a plurality of origin locations, and travel information, each origin location being associated with at least one traveler; and
at least one processing element capable of determining a set of suggested outbound and inbound itineraries between each origin location and the destination location, based upon the travel information, from a travel database comprising at least outbound and inbound itineraries between the origin locations and the destination location, each suggested outbound and inbound itinerary comprising an arrival time and a departure time with respect to the destination location, and the set of suggested outbound and inbound itineraries collectively providing an optimal time together of the travelers at the destination location.

19. A system according to claim 18 wherein the at least one processing element is further capable of determining an actual time together of the travelers as a difference between a latest arrival time of the travelers at the destination location and an earliest departure time the travelers from the destination location, from the set of suggested outbound and inbound itineraries of the travelers.

20. A system according to claim 19 wherein the at least one processing element is further capable of determining a total arrival wait time as a sum of differences between the latest arrival time and each arrival time for the set of suggested outbound and inbound itineraries, and a total departure wait time as a sum of differences between each departure time for the set of suggested outbound and inbound itineraries and the earliest departure time.

21. A system according to claim 20 wherein the at least one processing element is further capable of determining an actual travel time and any layover time for each of the set of suggested outbound and inbound itineraries, a sum of the total arrival wait time, the total departure wait time, and any layover times comprising a total wait time, and a sum of the actual travel times comprising a total travel time.

22. A system according to claim 21 wherein the at least one processing element is further capable of determining a cost for each of the set of suggested outbound and inbound itineraries, a sum of the costs comprising a total cost.

23. A system according to claim 22 wherein the at least one processing element is further capable of determining, for the set of suggested outbound and inbound itineraries, a weighted average of the actual time together, the total wait time, the total travel time, and the total cost, the weighted average being associated with the optimal time together of the travelers at the destination location.

24. A system according to claim 23 wherein the at least one processing element is further capable of comparing the weighted average for one set of suggested outbound and inbound itineraries to the weighted average of at least one other set of suggested outbound and inbound itineraries so as to determine the optimal time together of the travelers at the destination location.

25. A system according to claim 18 wherein the at least one processing element is further capable of determining a weighted average by assigning a monetary cost factor to each of the total wait time, the total travel time, and the total cost, and by assigning a monetary benefit factor to the actual time together, the monetary benefit factor having a greater absolute value than the monetary cost factor.

26. A system according to claim 18 wherein the at least one processing element is further capable of identifying an alternate set of suggested outbound and inbound itineraries by applying a qualitative criteria to the outbound and inbound itineraries in the travel database, the qualitative criteria being at least one of a lowest cost, a maximum time together, and proximately-grouped arrival and departure times.

27. A system according to claim 18 wherein the at least one client element is further capable of receiving an indication of a relative weight between price and schedule for at least one of the set of outbound and inbound itineraries, and the at least one processing element is further capable of determining a set of suggested outbound and inbound itineraries at least partially based upon the indication of the relative weight, from the travel database of the outbound and inbound itineraries between each origin location and the destination location.

28. A system according to claim 18 further comprising at least one display element capable of presenting at least the set of suggested outbound and inbound itineraries for review, wherein the at least one client element is further capable of receiving an indication that alternative itineraries are desired for at least one of the outbound and inbound itineraries associated with one of the travelers in the set of suggested outbound and inbound itineraries.

29. A system according to claim 28 wherein the at least one display element is further capable of presenting at least one other suggested outbound and inbound itinerary between the destination location and an origin location for review in response to the received indication; the at least one client element is further capable of receiving an indication of a selection of one of the at least one other suggested outbound and inbound itinerary; and the at least one processing element is further capable of modifying the set of the suggested outbound and inbound itineraries to include the selected one of the at least one other suggested outbound and inbound itinerary.

30. A system according to claim 18 further comprising at least one display element capable of presenting information associated with at least one of the destination location, a hotel at the destination location, and a rental vehicle at the destination location, in conjunction with presenting at least the set of suggested outbound and inbound itineraries for review.

31. A system according to claim 18 wherein the at least one client element is further capable of receiving hotel rental requirements associated with at least one of the travelers, and wherein the at least one processing element is further capable of identifying at least one hotel itinerary, from hotel rental information for the destination location in a travel database, based upon the hotel rental requirements.

32. A system according to claim 31 further comprising at least one display element capable of presenting the identified at least one hotel itinerary for review, wherein the at least one client element is further capable of receiving an indication of a selected hotel itinerary from the identified at least one hotel itinerary.

33. A system according to claim 18 wherein the at least one client element is further capable of receiving car rental requirements associated with at least one of the travelers, and wherein the at least one processing element is further capable of identifying at least one car rental itinerary, from car rental information for the destination location in a travel database, based upon the car rental requirements.

34. A system according to claim 33 further comprising at least one display element capable of presenting the identified at least one car rental itinerary for review, wherein the at least one client element is further capable of receiving an indication of a selected car rental itinerary from the identified at least one car rental itinerary.

35. A system according to claim 18 wherein the at least one client element is further capable of receiving travel information regarding at least one of the travelers via at least one of a push-type syndicated information source and a pull-type syndicated information retrieval system.

36. A system according to claim 18 wherein the at least one processing element is further capable of determining a plurality of sets of suggested outbound and inbound itineraries between each origin location and the destination location, based upon the travel information, from a travel database using one of an affinity procedure and an extrapolation procedure.

37. A system according to claim 36 wherein the at least one processing element is further capable of limiting the plurality of sets of suggested outbound and inbound itineraries between each origin location and the destination location, by applying a pruning procedure thereto.

38. A method for coordinating outbound and inbound itineraries for a plurality of travelers, comprising:
receiving a destination location, a plurality of origin locations, and travel information, each origin location being associated with at least one traveler;
determining at least one suggested outbound and inbound itinerary between each origin location and the destination location, based upon the travel information, from a travel database comprising at least outbound and inbound itineraries between the origin locations and the destination location; and
concurrently presenting one of an outbound portion and an inbound portion of the suggested outbound and inbound itineraries, arranged according to the corresponding origin location, the one of the outbound portion and the inbound portion of the at least one suggested outbound and inbound itinerary for one of the plurality of origin locations being sortable according to an attribute of the suggested outbound and inbound itineraries, discretely of the corresponding one of the outbound portion and the inbound portion of the at least one suggested outbound and inbound itinerary for each of the others of the plurality of origin locations.

39. A method according to claim 38 further comprising sorting the one of the outbound portion and the inbound portion of the at least one suggested outbound and inbound itinerary for one of the plurality of origin locations according to an attribute comprising one of a selected airline, an arrival time with respect to the destination location, a departure time with respect to the destination location, a total travel time, an amount of stops between the origin location and the destination location, and a cost.

40. A method according to claim 38 wherein concurrently presenting one of an outbound portion and an inbound portion of the suggested outbound and inbound itineraries further comprises concurrently presenting one of the outbound portion and the inbound portion of the suggested outbound and inbound itineraries in adjacent columns arranged according to the origin locations.

41. A system for coordinating outbound and inbound itineraries for a plurality of travelers, comprising:
at least one client element capable of receiving a destination location, a plurality of origin locations, and travel information, each origin location being associated with at least one traveler; and
at least one processing element capable of determining at least one suggested outbound and inbound itinerary between each origin location and the destination location, based upon the travel information, from a travel database comprising at least outbound and inbound itineraries between the origin locations and the destination location, the at least one processing element being further capable of concurrently presenting one of an outbound portion and an inbound portion of the suggested outbound and inbound itineraries, arranged according to the corresponding origin location, on the at least one client element such that the one of the outbound portion and the inbound portion of the at least one suggested outbound and inbound itinerary for one of the plurality of origin locations is sortable according to an attribute of the suggested outbound and inbound itineraries, discretely of the corresponding one of the outbound portion and the inbound portion of the at least one suggested outbound and inbound itinerary for each of the others of the plurality of origin locations.

42. A system according to claim 42 wherein the at least one processing element is further capable of sorting the one of the outbound portion and the inbound portion of the at least one suggested outbound and inbound itinerary for one of the plurality of origin locations according to an attribute comprising one of a selected airline, an arrival time with respect to the destination location, a departure time with respect to the destination location, a total travel time, an amount of stops between the origin location and the destination location, and a cost

43. A system according to claim 42 wherein the at least one processing element is further capable of concurrently presenting the one of the outbound portion and the inbound portion of the suggested outbound and inbound itineraries in adjacent columns arranged according to the origin locations on the at least one client element.
